(19) United States
(12) Patent Application Publication
(10) Pub. No.: US 2025/0038765 A1
(43) Pub. Date: Jan. 30, 2025

(54) DEEP LEARNING ARCHITECTURE FOR OPERATING ON HOMOMORPHICALLY COMPRESSED AND ENCRYPTED DATA

(71) Applicant: AtomBeam Technologies Inc., Moraga, CA (US)

(72) Inventor: Brian Galvin, Silverdale, WA (US)

(21) Appl. No.: 18/914,240

(22) Filed: Oct. 13, 2024

Related U.S. Application Data
(63) Continuation-in-part of application No. 18/770,652, filed on Jul. 12, 2024.
Application No. 18/770,652 is a continuation-in-part of application No. 18/503,135, filed on Nov. 6, 2023.
Application No. 18/503,135 is a continuation of application No. 18/305,305, filed on Apr. 21, 2023, now Pat. No. 11,811,428.
Application No. 18/305,305 is a continuation-in-part of application No. 18/190,044, filed on Mar. 24, 2023, now Pat. No. 11,831,343.
Application No. 18/190,044 is a continuation-in-part of application No. 17/875,201, filed on Jul. 27, 2022, now Pat. No. 11,700,013.
Application No. 17/875,201 is a continuation of application No. 17/514,913, filed on Oct. 29, 2021, now Pat. No. 11,424,760.
Application No. 17/514,913 is a continuation-in-part of application No. 17/404,699, filed on Aug. 17, 2021, now Pat. No. 11,385,794.
Application No. 17/404,699 is a continuation-in-part of application No. 16/455,655, filed on Jun. 27, 2019, now Pat. No. 10,509,771.
Application No. 16/455,655 is a continuation-in-part of application No. 16/200,466, filed on Nov. 26, 2018, now Pat. No. 10,476,519.
Application No. 16/200,466 is a continuation-in-part of application No. 15/975,741, filed on May 9, 2018, now Pat. No. 10,303,391.
Application No. 17/875,201 is a continuation of application No. 17/458,747, filed on Aug. 27, 2021, now Pat. No. 11,422,978.
Application No. 17/458,747 is a continuation-in-part of application No. 16/923,039, filed on Jul. 7, 2020, now Pat. No. 11,232,076.
Application No. 16/923,039 is a continuation-in-part of application No. 16/716,098, filed on Dec. 16, 2019, now Pat. No. 10,706,018.
Application No. 16/716,098 is a continuation of application No. 16/455,655, filed on Jun. 27, 2019, now Pat. No. 10,509,771.
Application No. 16/455,655 is a continuation-in-part of application No. 17/727,913, filed on Apr. 25, 2022, now Pat. No. 11,620,051.
Application No. 17/727,913 is a continuation of application No. 17/404,699, filed on Aug. 17, 2021, now Pat. No. 11,385,794.
Application No. 17/404,699 is a continuation-in-part of application No. 17/234,007, filed on Apr. 19, 2021, now Pat. No. 11,782,879.
Application No. 17/234,007 is a continuation-in-part of application No. 17/180,439, filed on Feb. 19, 2021, now Pat. No. 11,366,790.
Application No. 17/180,439 is a continuation-in-part of application No. 16/923,039, filed on Jul. 7, 2020, now Pat. No. 11,232,076.
(63) Continuation-in-part of application No. 18/755,627, filed on Jun. 26, 2024.
(63) Continuation-in-part of application No. 18/737,906, filed on Jun. 7, 2024.
(60) Provisional application No. 62/578,824, filed on Oct. 30, 2017.
(60) Provisional application No. 63/027,166, filed on May 19, 2020.
(60) Provisional application No. 62/926,723, filed on Oct. 28, 2019.
(60) Provisional application No. 63/388,411, filed on Jul. 12, 2022.
(60) Provisional application No. 63/485,518, filed on Feb. 16, 2023.
(60) Provisional application No. 63/232,041, filed on Aug. 11, 2021.
(60) Provisional application No. 63/140,111, filed on Jan. 21, 2021.

(51) Int. Cl. H03M 7/30; G06N 20/00

(52) U.S. Cl. CPC H03M 7/3059; G06N 20/00; H03M 7/6005

(57) ABSTRACT

The codebook-based homomorphic compression system is a novel approach that combines data compression and homomorphic encryption to enable efficient and secure computation on compressed data. It involves quantizing the input data, generating an optimized codebook using techniques like Huffman coding or deep learning, and compressing the data by replacing each value with its corresponding codeword. The compressed data is then encrypted using a homomorphic encryption scheme, allowing computations to be performed directly on the encrypted compressed data without decryption. The system includes a deep learning architecture trained on and operating on the homomorphically compressed and encrypted data, enabling inference and decision-making while maintaining data privacy. This approach combines the benefits of data compression, homomorphic encryption, and deep learning, enabling efficient storage, transmission, and secure computation on compressed data streams.

### CROSS-REFERENCE TO RELATED APPLICATIONS

Priority is claimed in the application data sheet to the following patents or patent applications, each of which is expressly incorporated herein by reference in its entirety:
U.S. Ser. Nos. 18/755,627
18/737,906
18/770,652
18/503,135
18/305,305
18,190,044
17/875,201
17/514,913
17/404,699
16,455,655
17/458,747
16/923,039
63/027,166
16/716,098
16/200,466
15/975,741
62/578,824
62/926,723
63/388,411
17/727,913
63/485,518
63/232,041
17/234,007
17/180,439
63/140,111

### BACKGROUND OF THE INVENTION

### Field of the Art

The present invention relates to the field of data compression and privacy-preserving computation, training a deep learning model on compressed and encrypted information.

### Discussion of the State of the Art

Data compression plays an important role in reducing storage and transmission costs in various domains, such as IoT, cloud computing, and big data analytics. Existing compression techniques, such as entropy coding (e.g., Huffman coding, arithmetic coding) and dictionary-based methods (e.g., LZ77, LZ78), have been widely used to compress data efficiently. However, these traditional compression methods do not inherently support computations on the compressed data, limiting their applicability in scenarios that require privacy-preserving processing or direct operations on compressed representations.

Homomorphic encryption has emerged as a promising solution for enabling computations on encrypted data without requiring decryption. Fully homomorphic encryption (FHE) schemes, such as the Brakerski-Gentry-Vaikuntanathan (BGV) scheme and the Cheon-Kim-Kim-Song (CKKS) scheme, allow arbitrary computations on encrypted data. However, FHE schemes often result in significant ciphertext expansion and computational overhead, making them impractical for many real-world applications.

Attempts have been made to combine data compression with homomorphic encryption to reduce the ciphertext size and improve computational efficiency. For example, the work by Liu et al. (2019) proposed a compression scheme for homomorphic encrypted data using a combination of quantization and encoding techniques. Another approach by Chen et al. (2020) utilized a deep learning-based compression framework to compress homomorphic encrypted data. While these methods achieve some level of compression, they rely on specific encryption schemes and do not provide a general framework for enabling computations on compressed data.

The current state of the art lacks a comprehensive solution that seamlessly integrates data compression with homomorphic properties, allowing for efficient storage, transmission, and processing of compressed data while preserving privacy. Existing methods either focus on traditional compression techniques without considering homomorphic operations or rely on specific encryption schemes that introduce significant overhead.

Therefore, there is a need for a novel approach that combines the benefits of data compression and homomorphic computation, enabling efficient and privacy-preserving processing of compressed data. The proposed codebook-based homomorphic compression technique addresses this need by providing a general framework that allows for direct computations on compressed data without relying on specific encryption schemes. By quantizing the data, generating an optimized codebook, and performing homomorphic operations on the compressed representations, the technique achieves significant compression ratios while enabling essential computations, such as addition, subtraction, and averaging, directly on the compressed data.

The proposed invention advances the state of the art by providing a practical and efficient solution for homomorphic compression, opening up new possibilities for privacy-preserving data processing and analysis in various domains, such as IoT, cloud computing, and secure data analytics.

### SUMMARY OF THE INVENTION

Accordingly, the inventor has conceived and reduced to practice, a system and method for operating a deep learning architecture on homomorphically compressed and encrypted data. It involves quantizing the input data, generating an optimized codebook using techniques like Huffman coding or deep learning, and compressing the data by replacing each value with its corresponding codeword. The compressed data is then encrypted using a homomorphic encryption scheme, such as the Paillier cryptosystem, allowing computations to be performed directly on the encrypted compressed data without decryption. Homomorphic properties of the encryption scheme enable operations like addition and multiplication on the ciphertexts, while preserving the confidentiality of the underlying data. The system also incorporates error correction techniques to mitigate the impact of quantization and encryption on the accuracy of the computations. This approach combines the benefits of data compression and homomorphic encryption, enabling efficient storage, transmission, and secure computation on compressed data.

According to a preferred embodiment, a system for operating a deep learning architecture on homomorphically compressed and encrypted data, comprising one or more computers with executable instructions that, when executed, cause the deep learning system to: sense input data from a data source; compress the input data into a plurality of compressed codewords by allocating codewords to sections of the input data; encrypt the plurality of compressed codewords into a plurality of encrypted and compressed codewords using a homomorphic encryption algorithm; process the plurality encrypted and compressed codewords through a machine learning core, wherein the machine learning core produces a plurality of inferences based on the encrypted and compressed codewords; and modify the data source or the input data based on the plurality of inferences, is disclosed.

According to another preferred embodiment, a method for operating a deep learning architecture on homomorphically compressed and encrypted data, comprising the steps of: sensing input data from a data source; compressing the input data into a plurality of compressed codewords by allocating codewords to sections of the input data; encrypting the plurality of compressed codewords into a plurality of encrypted and compressed codewords using a homomorphic encryption algorithm; processing the plurality encrypted and compressed codewords through a machine learning core, wherein the machine learning core produces a plurality of inferences based on the encrypted and compressed codewords; and modifying the data source or the input data based on the plurality of inferences.

According to an aspect of an embodiment, the machine learning core uses a latent transformer architecture.

According to an aspect of an embodiment, the machine learning core produces a plurality of predictions based on the plurality of encrypted and compressed codewords.

According to an aspect of an embodiment, the input data is quantized before allocating codewords to sections of the input data.

### BRIEF DESCRIPTION OF THE DRAWING FIGURES

FIG. 1 is a block diagram illustrating an exemplary system architecture for codebook-based homomorphic encryption, according to an embodiment.

FIG. 2 is a block diagram illustrating an exemplary aspect of a system for codebook-based homomorphic encryption, a data quantization subsystem.

FIG. 3 is a block diagram illustrating an exemplary aspect of a system for codebook-based homomorphic encryption, a codebook generation subsystem.

FIG. 4 is a block diagram illustrating an exemplary aspect of a system for codebook-based homomorphic encryption, a compression subsystem.

FIG. 5 is a block diagram illustrating an exemplary aspect of a system for codebook-based homomorphic encryption, a homomorphic subsystem.

FIG. 6 is a flow diagram illustrating an exemplary method for performing data quantization on input data, according to an aspect.

FIG. 7 is a flow diagram illustrating an exemplary method for performing codebook generation using Huffman coding, according to an aspect.

FIG. 8 is a flow diagram illustrating an exemplary method for performing codebook generation using arithmetic coding, according to an aspect.

FIG. 9 is a flow diagram illustrating an exemplary method for performing codebook generation using a deep learning model, according to an aspect.

FIG. 10 is a flow diagram illustrating an exemplary method for performing compression using the generation codebooks, according to an aspect.

FIG. 11 is a flow diagram illustrating an exemplary method for performing homomorphic encryption using the Paillier cryptosystem, according to an aspect.

FIG. 12 is a diagram showing an embodiment of the system in which all components of the system are operated locally.

FIG. 13 is a diagram showing an embodiment of one aspect of the system, the data deconstruction engine.

FIG. 14 is a diagram showing an embodiment of one aspect of the system, the data reconstruction engine.

FIG. 15 is a block diagram illustrating an exemplary system architecture for combining data compression with genomic encryption techniques.

FIG. 16 is a block diagram illustrating an exemplary system architecture for decompressing and decrypting incoming data that was processed using prefix tables and BWT.

FIG. 17 is a flow diagram illustrating an exemplary method for compressing and encrypting data using prefix tables and BWT.

FIG. 18 is a flow diagram illustrating an exemplary method for decrypting and decompressing genomic data using prefix tables and BWT.

FIG. 19 is a block diagram illustrating an exemplary system architecture for a dyadic distribution-based compression and encryption platform, according to an embodiment.

FIG. 20 is a block diagram illustrating another exemplary system architecture for a dyadic distribution-based compression and encryption platform, according to an embodiment.

FIG. 21 is a flow diagram illustrating an exemplary method for implementing a dyadic distribution algorithm, according to an aspect.

FIG. 22 is a flow diagram illustrating an exemplary method for providing lossless, dyadic distribution-based compression and encryption, according to an aspect.

FIG. 23 is a flow diagram illustrating an exemplary method for providing lossy, dyadic distribution-based compression and encryption, according to an aspect.

FIG. 24 is a flow diagram illustrating an exemplary method for providing modified lossless, dyadic distribution-based compression and encryption, according to an aspect.

FIG. 25 is a block diagram illustrating an exemplary system architecture for processing homomorphic compressed and encrypted data through a deep learning platform.

FIG. 26 is a block diagram illustrating an exemplary system architecture for decompressing and decrypting homomorphic compressed and encrypted data after being processed by deep learning platform.

FIG. 27 is a block diagram illustrating an exemplary system architecture for a latent transformer core, which is a possible machine learning core for processing homomorphic compressed and encrypted data through a deep learning platform.

FIG. 28 is a block diagram illustrating a component of the system processing homomorphic compressed and encrypted data through a deep learning platform, a Latent Transformer.

FIG. 29 is a block diagram illustrating a component of the system for processing homomorphic compressed and encrypted data through a deep learning platform, a machine learning core training system.

FIG. 30 is a flow diagram illustrating an exemplary method for processing homomorphic compressed and encrypted data through a deep learning platform.

FIG. 31 is a flow diagram illustrating an exemplary method for decompressing and decrypting homomorphic compressed and encrypted data after being processed by deep learning platform.

FIG. 32 is a flow diagram illustrating an exemplary method for training a machine learning core on processing homomorphic compressed and encrypted data.

FIG. 33 illustrates an exemplary computing environment on which an embodiment described herein may be implemented.

### DETAILED DESCRIPTION OF THE INVENTION

The inventor has conceived, and reduced to practice, a system and method for operating a deep learning architecture on homomorphically compressed and encrypted data. It involves quantizing the input data, generating an optimized codebook using techniques like Huffman coding or deep learning, and compressing the data by replacing each value with its corresponding codeword. The compressed data is then encrypted using a homomorphic encryption scheme, such as the Paillier cryptosystem, allowing computations to be performed directly on the encrypted compressed data without decryption. Homomorphic properties of the encryption scheme enable operations like addition and multiplication on the ciphertexts, while preserving the confidentiality of the underlying data. The system also incorporates error correction techniques to mitigate the impact of quantization and encryption on the accuracy of the computations. This approach combines the benefits of data compression and homomorphic encryption, enabling efficient storage, transmission, and secure computation on compressed data.

The system addresses the intersection of data compression and homomorphic computation, seeking to develop a novel approach that combines the benefits of both domains. By enabling homomorphic operations on compressed data, the system aims to achieve efficient and privacy-preserving processing of large-scale datasets, such as those encountered in IoT, cloud computing, and data analytics applications.

According to various embodiments, the system may encompass various techniques and methods related to data compression, including entropy coding (e.g., Huffman coding, arithmetic coding), dictionary-based compression (e.g., LZ77, LZ78), and transform-based compression (e.g., discrete cosine transform, wavelet transform). It may also utilize the study of homomorphic encryption schemes, such as fully homomorphic encryption (FHE) and somewhat homomorphic encryption (SHE), which enable computations on encrypted data.

Furthermore, the supports the use of secure multi-party computation (MPC), which allows multiple parties to jointly compute a function on their private inputs without revealing the inputs to each other. The system focuses on enabling computations on compressed data has implications for secure MPC protocols, as it can potentially reduce the communication and computational overhead associated with processing large amounts of data.

The codebook-based homomorphic compression system lies at the intersection of these subfields, aiming to develop a novel technique that combines the principles of data compression, homomorphic encryption, and secure computation. By advancing the state of the art in these areas, the system seeks to enable more efficient, scalable, and privacy-preserving processing of data in various applications, contributing to the broader field of secure and efficient data management.

The codebook-based homomorphic compression system has numerous applications across various domains, particularly in scenarios where data compression and privacy-preserving computations are crucial. Some key applications and advantages include: Internet of Things (IoT), Privacy-Preserving Data Analytics, Secure Cloud Computing, Efficient Data Transmission, and Secure Data Storage.

IoT devices generate massive amounts of data that need to be efficiently transmitted and processed. The disclosed system enables compression of IoT data streams while allowing for homomorphic operations, reducing bandwidth requirements and enabling privacy-preserving analytics on the compressed data. For example, in a smart city scenario, sensors can compress traffic data using the system, and the compressed data can be aggregated and analyzed without revealing individual sensor readings.

The system enables analytics to be performed on compressed data without requiring access to the original uncompressed data. This is particularly advantageous in scenarios where sensitive or confidential data needs to be analyzed while maintaining privacy. For instance, in healthcare, patient data can be compressed using the system, and researchers can perform statistical analysis or machine learning on the compressed data without accessing individual patient records.

Cloud computing often involves storing and processing large amounts of data on remote servers. The system allows data to be compressed before uploading to the cloud, reducing storage and bandwidth costs. Moreover, the homomorphic properties of the compression enable computations to be performed on the compressed data in the cloud, without the need for decryption, enhancing data security and privacy. For example, an e-commerce platform can compress customer data using the system and perform analytics on the compressed data in the cloud, ensuring customer privacy.

The system can achieve significant data compression ratios, reducing the size of the data that needs to be transmitted over networks. This is particularly beneficial in scenarios where bandwidth is limited or costly, such as wireless sensor networks or satellite communications. By compressing the data using the system, more data can be transmitted using the same bandwidth, improving efficiency and reducing transmission costs.

The system enables data to be stored in a compressed format while still allowing for homomorphic operations. This reduces storage requirements and enhances data security, as the compressed data can be stored without revealing the original content. For instance, in a cloud storage scenario, user files can be compressed using the system before being stored in the cloud, ensuring data confidentiality and reducing storage costs.

The codebook-based homomorphic compression system offers significant advantages in terms of data compression, privacy-preserving computations, and efficient data transmission and storage. It enables organizations to process and analyze data in a secure and efficient manner, opening up new possibilities for data-driven insights and decision-making while preserving data privacy.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “homomorphic encryption” refers to a form of encryption that allows computations to be carried out on ciphertext, thus generating an encrypted result that, when decrypted, matches the result of the operations as if they had been performed on the plaintext. In other words, it enables computation on encrypted data without decrypting it first. This property is valuable for privacy-preserving computation, as it allows for secure outsourcing of data processing while keeping the data encrypted.

### Conceptual Architecture

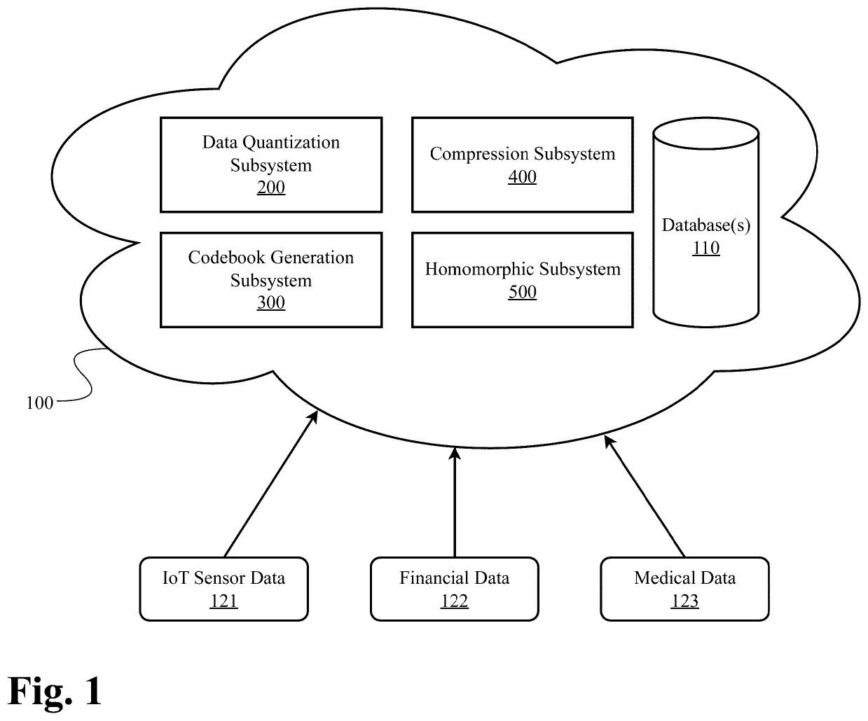

FIG. 1 is a block diagram illustrating an exemplary system architecture for codebook-based homomorphic encryption 100, according to an embodiment. According to the embodiment, system 100 is configured as a cloud-based computing platform comprising various system or sub-system components configured to provide functionality directed to the execution of codebook-based homomorphic encryption. Exemplary platform subsystems can include a data quantization subsystem 200, a codebook generation subsystem 300, a compression subsystem 400, and a homomorphic subsystem 500. In some embodiments, systems 200-500 may each be implemented as standalone software applications or as a services/microservices architecture which can be deployed (via platform 100) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker and orchestrated using container orchestration platforms like Kubernetes. This allows for easier deployment and management of services.

As shown the system may comprise one or more databases and/or data storage systems 110 configured to store a plurality of data such as, quantized data, codewords and codebooks, compressed data, machine learning and/or deep learning algorithms/models, model training data, schemas, rules, policies, preferences, and/or the like. Examples of the types of databases that may be implemented include, but are not limited to, graph databases, vector databases, relational databases, document databases, key-value databases, distributed key-value stores, time series databases, NoSQL databases, in memory databases, and cloud-based storage systems.

The system 100 may process and homomorphically encrypt various types of input data. Some examples of the types of input data that can be processed include, but are not limited to, Internet-of-Things (IoT) sensor data 121, financial data 122, and medical data 123.

According to an embodiment, data quantization subsystem 200 is present and configured for dividing the range of the input data into a finite set of intervals, each represented by a unique codeword. The quantization process discretizes the continuous or high-precision input data into a smaller set of discrete values, reducing the complexity and size of the data representation. The number and size of the intervals can be determined based on the desired trade-off between compression ratio and approximation accuracy. Various quantization techniques can be employed, such as uniform quantization, where the intervals are of equal size, or non-uniform quantization, where the interval sizes vary based on the data distribution. The output of the quantization step is a mapping between the original input data and the corresponding codewords, which serves as the basis for the subsequent codebook generation and compression steps in the homomorphic compression pipeline.

According to an embodiment, codebook generation subsystem 300 is present and responsible for creating a compact and efficient representation of the quantized data. It involves assigning unique codewords to each interval of the quantized data based on a selected codebook generation technique. The choice of the codebook generation technique depends on factors such as the desired compression ratio, the complexity of the data, and the efficiency of the encoding and decoding processes. Common techniques include Huffman coding, which assigns shorter codewords to more frequent intervals and longer codewords to less frequent intervals, and arithmetic coding, which represents the entire dataset as a single fractional number. Other advanced techniques, such as entropy-based coding or machine learning-based approaches, can also be employed to generate optimized codebooks. The resulting codebook is a mapping between the quantized intervals and their corresponding codewords, enabling efficient compression and decompression of the data while preserving the essential information for subsequent homomorphic operations.

According to an embodiment, compression subsystem 400 is present and configured for efficiently encoding the quantized data using the generated codebook. It may comprise replacing each quantized interval in the input data with its corresponding codeword from the codebook. This process significantly reduces the size of the data representation, as the codewords are typically much shorter than the original data values. The compression is achieved by exploiting the redundancy and patterns present in the quantized data, with more frequent intervals being assigned shorter codewords and less frequent intervals being assigned longer codewords. The output of the compression step is a compressed representation of the original data, where each data point is replaced by its corresponding codeword. This compressed representation is compact and efficient, enabling faster transmission, storage, and processing of the data. The compression step may be lossless, meaning that the original quantized data can be perfectly reconstructed from the compressed representation using the codebook, ensuring data integrity and enabling accurate homomorphic operations on the compressed data.

According to an embodiment, homomorphic subsystem 500 is present and configured for enabling computation directly on the compressed data without the need for decompression. It leverages the properties of homomorphic encryption schemes to perform operations such as addition, subtraction, and multiplication on the compressed codewords, while preserving the confidentiality and integrity of the underlying data. The homomorphic component allows for the execution of various algorithms and analysis techniques on the compressed data, without revealing the original sensitive information. This is achieved by exploiting the mathematical structure of the codebook and the homomorphic encryption scheme, ensuring that the results of the homomorphic operations on the codewords correspond to the same operations on the original uncompressed data. The homomorphic component enables privacy-preserving computation and reduces the computational overhead associated with traditional encryption-decryption cycles. It opens up possibilities for secure and efficient data processing in various domains, such as cloud computing, multi-party computation, and privacy-preserving machine learning, while maintaining the confidentiality and integrity of the data throughout the computation process.

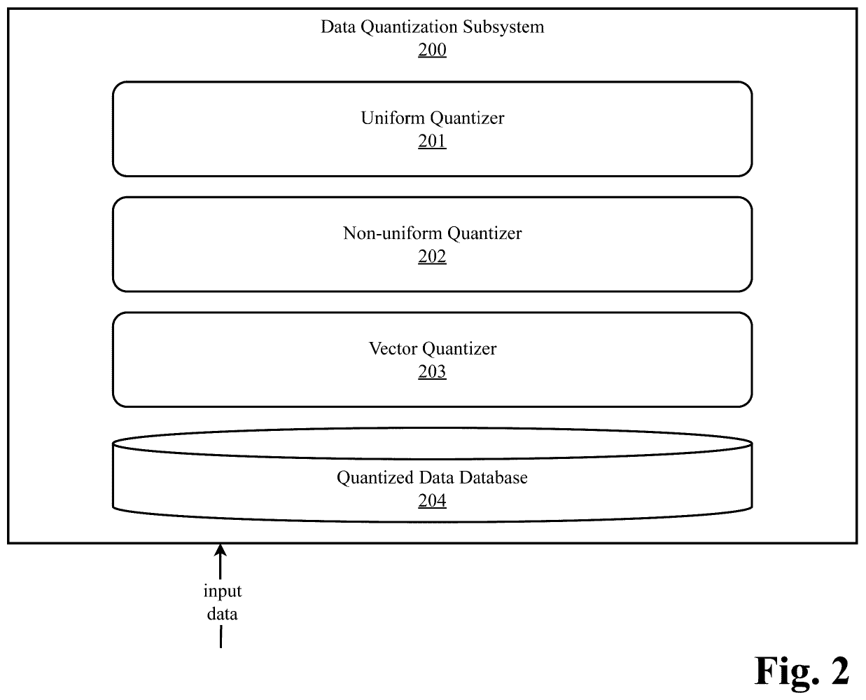

FIG. 2 is a block diagram illustrating an exemplary aspect of a system for codebook-based homomorphic encryption, a data quantization subsystem. According to the aspect, data quantization subsystem 200 is configured to divide a data range into fixed-size intervals and assigning codes to each interval using various data quantization techniques.

Quantization is the process of mapping a continuous range of values to a discrete set of values. In the context of codebook-based homomorphic compression, quantization may be used to discretize the input data into a finite set of intervals, each represented by a unique code. The quantization process comprises dividing the range of the input data into fixed-size intervals. The size of the intervals determines the granularity of the quantization and affects the trade-off between compression ratio and approximation accuracy. Smaller intervals lead to higher accuracy but may result in a larger codebook and lower compression ratios, while larger intervals achieve better compression but introduce more approximation error. There are various quantization techniques that can be employed, depending on the nature of the data and the desired properties. According to the embodiment, a uniform quantizer 201 component is present. In uniform quantization, the data range is divided into intervals of equal size. Each interval is assigned a unique code, typically an integer value. For example, if the data range is [0, 100] and it is divided into 10 intervals, each interval would have a size of 10, and the codes would be {0, 1, 2, . . . , 9}.

According to the embodiment, a non-uniform quantizer component 202 is present. Non-uniform quantization allows for intervals of varying sizes, adapting to the distribution of the data. This can be beneficial when the data has a non-uniform distribution, as it allows for more precise representation of frequently occurring values. One common approach is logarithmic quantization, where the interval sizes increase logarithmically, providing more precision for smaller values and less precision for larger values, c.

According to the embodiment, a vector quantizer component 203 is present. Vector quantization extends the concept of quantization to multi-dimensional data. Instead of quantizing individual scalar values, vector quantization operates on vectors or blocks of data. The data is divided into fixed-size vectors, and each vector is mapped to the nearest codeword in a predefined codebook. Vector quantization can exploit correlations and patterns within the data, leading to more efficient compression.

As an example of the data quantization process consider an example of quantizing temperature data from an IoT sensor. The temperature values range from −10° C. to 50° C. Data quantization subsystem 200 can apply uniform quantization by dividing this range into 20 intervals, each of size 3° C. The intervals and their corresponding codes would be:
Interval 1: [−10, −7), Code: 0
Interval 2: [−7, −4), Code: 1
Interval 20: [47,50], Code: 19

A temperature value of 25.6° C. would be quantized to the interval [25, 28) and assigned the code 11.

Quantized data may be stored in a quantized data database 204 which may be implemented as one or more appropriate data storage systems. There are several database systems and data storage solutions that can be used to store the quantized data in the codebook-based homomorphic compression system. The choice of the storage system depends on factors such as the volume of data, the required retrieval and query performance, scalability needs, and the overall system architecture. In some implementations, relational databases, such as MySQL, PostgreSQL, or Oracle, may be used for structured data storage. They provide a table-based structure where data is organized into rows and columns, with each table representing a specific entity or concept. In the context of storing quantized data, relational databases can be used to store the quantized values along with their corresponding metadata, such as timestamps, sensor IDs, or other relevant attributes. The quantized data can be stored in a table with columns representing the quantized values and associated metadata. Relational databases offer strong consistency, ACID (Atomicity, Consistency, Isolation, Durability) properties, and support for complex queries using SQL (Structured Query Language). They are suitable for scenarios where data integrity, structured queries, and transactions are important.

In some implementations, NoSQL (Not Only SQL) databases may be utilized. NoSQL databases are designed to handle large volumes of unstructured or semi-structured data. They provide flexible schemas and can scale horizontally to accommodate growing data sizes.

Examples of NoSQL databases include MongoDB, Cassandra, and Apache HBase. For storing quantized data, NoSQL databases can be used to store the quantized values as key-value pairs, documents, or wide-column families. The quantized data can be stored alongside its associated metadata, allowing for efficient retrieval and querying. NoSQL databases offer high scalability, distributed architecture, and eventual consistency. They are well-suited for scenarios where scalability, high write throughput, and flexible data models are prioritized over strict consistency and complex querying capabilities.

Time series databases may be implemented and are optimized for storing and querying time-stamped data, making them suitable for storing quantized data that is generated over time, such as sensor readings or IoT data. Examples of time series databases include InfluxDB, TimescaleDB, and OpenTSDB. In a time series database, the quantized data can be stored as data points with timestamps. Each data point represents a quantized value at a specific time. Time series databases provide efficient indexing and querying capabilities based on time ranges, allowing for fast retrieval and analysis of quantized data over specific time intervals. Time series databases offer features such as data compression, downsampling, and aggregation, which can be beneficial for storing and querying large volumes of time-stamped quantized data.

Distributed file systems, such as Hadoop Distributed File System (HDFS) or Amazon S3, provide scalable and fault-tolerant storage for large-scale data. They are designed to store and process massive amounts of unstructured or semi-structured data across a cluster of commodity servers. For storing quantized data, distributed file systems can be used to store the quantized values as files or objects. The quantized data can be organized in a hierarchical directory structure based on timestamps, sensor IDs, or other relevant attributes. Distributed file systems offer high scalability, fault tolerance, and the ability to process data using distributed computing frameworks like Apache Hadoop or Apache Spark. Distributed file systems are suitable for scenarios where the quantized data volume is extremely large, and the data needs to be processed using distributed computing techniques.

In-memory databases store data primarily in the main memory (RAM) of the system, providing extremely fast read and write operations. Examples of in-memory databases include Redis, Apache Ignite, and VoltDB. For storing quantized data, in-memory databases can be used to store the quantized values in key-value pairs or data structures optimized for fast retrieval. In-memory databases offer low latency and high throughput, making them suitable for scenarios where real-time processing and fast data access are critical. In-memory databases can be used as a caching layer or as a primary storage solution for quantized data, depending on the specific requirements of the system.

Cloud storage services, such as Amazon S3, Google Cloud Storage, or Microsoft Azure Blob Storage, provide scalable and durable storage solutions for various types of data. They offer virtually unlimited storage capacity and high availability. For storing quantized data, cloud storage can be used to store the quantized values as objects or files. The quantized data can be organized in a hierarchical structure using object prefixes or directories. Cloud storage services provide features like versioning, replication, and access control, ensuring data durability and security. Cloud storage is suitable for scenarios where the quantized data needs to be stored and accessed remotely, and the system requires scalability and durability provided by cloud infrastructure.

These are just a few examples of database systems and data storage solutions that could be used to store the quantized data in the codebook-based homomorphic compression system. The choice of the storage system depends on the specific requirements of the application, such as data volume, retrieval performance, scalability needs, and the overall system architecture.

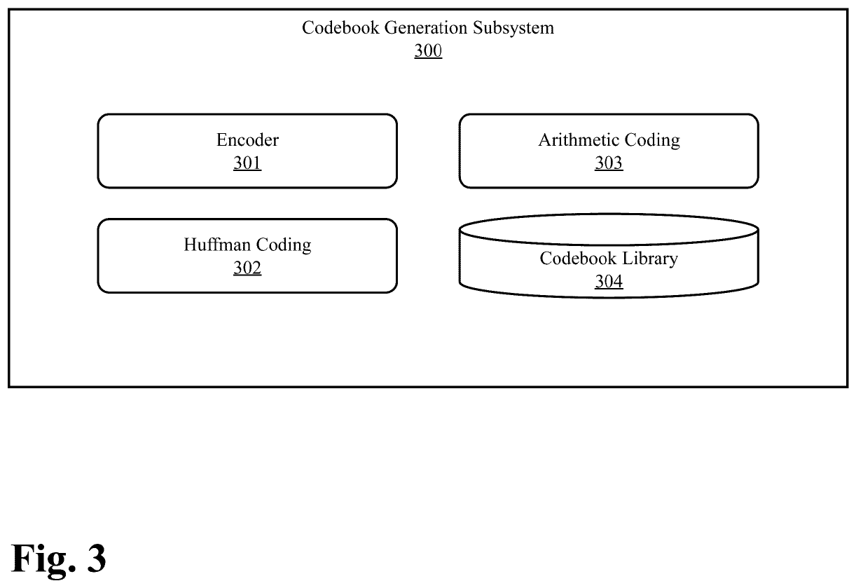

FIG. 3 is a block diagram illustrating an exemplary aspect of a system for codebook-based homomorphic encryption, a codebook generation subsystem. According to the aspect, codebook generation subsystem 300 is configured to generate one or more codebooks for a collection of input data using various techniques, such as Huffman coding or arithmetic coding.

The codebook is an important component of the codebook-based homomorphic compression system. According to the embodiment, it is a collection of codewords, where each codeword corresponds to a specific interval in the quantized data. The codebook may generated based on the frequency distribution of the quantized data, assigning shorter codewords to more frequently occurring intervals and longer codewords to less frequent intervals. There are several techniques for generating the codebook, with the goal of minimizing the average codeword length while maintaining the uniqueness of the codewords. Two common techniques are Huffman coding 302 and arithmetic coding 303. Huffman coding 302 is a variable-length coding technique that assigns codewords based on the frequency of occurrence of each symbol (interval). It constructs a binary tree, known as the Huffman tree, where each leaf node represents a symbol and the path from the root to the leaf determines the codeword. More frequent symbols are assigned shorter codewords, while less frequent symbols receive longer codewords. Huffman coding guarantees an optimal prefix code, meaning no codeword is a prefix of any other codeword. For example, consider the quantized temperature data from the previous example. Let's say the frequency distribution of the intervals is as follows:
Interval 0: 5%
Interval 1: 10%
Interval 2: 20%
Interval 3: 15%
Interval 4: 50%

Using Huffman coding, the subsystem 300 can generate the following codebook:
Interval 0: 1100
Interval 1: 101
Interval 2: 00
Interval 3: 01
Interval 4: 11

The most frequent interval (Interval 4) receives the shortest codeword (11), while the least frequent interval (Interval 0) receives the longest codeword (1100).

Arithmetic coding 303 is another entropy coding technique that assigns codewords to intervals based on their probability distribution. Unlike Huffman coding, arithmetic coding does not assign fixed codewords to symbols. Instead, it represents the entire message as a single fractional number between 0 and 1. The interval [0, 1) is recursively divided based on the probabilities of the symbols, and the final codeword is a binary fraction that falls within the subinterval corresponding to the entire message. Arithmetic coding achieves near-optimal compression rates but requires more computational complexity compared to Huffman coding. For example, using the same quantized temperature data and frequency distribution as before, arithmetic coding would assign subintervals to each symbol based on their probabilities:
Interval 0: [0.00, 0.05)
Interval 1: [0.05, 0.15)
Interval 2: [0.15, 0.35)
Interval 3: [0.35, 0.50)
Interval 4: [0.50, 1.00)

To encode a message sequence like [Interval 4, Interval 2, Interval 1], arithmetic coding would recursively subdivide the interval [0, 1) based on the probabilities of the symbols, resulting in a final subinterval. The codeword would be a binary fraction that lies within this final subinterval.

According to an embodiment, an encoder component 301 is present and configured to implement one or more deep learning techniques for generating codewords for quantized data. Deep learning techniques can be employed to generate effective codewords for the quantized data. One approach is to use deep learning-based autoencoder models to learn compact and meaningful representations of the quantized data. Autoencoders are neural network architectures that consist of an encoder and a decoder, where the encoder learns to compress the input data into a lower-dimensional latent space, and the decoder reconstructs the original data from the latent representation.

Here are a few exemplary deep learning encoding techniques that can be implemented for creating codewords of the quantized data, according to an embodiment. Convolutional autoencoders (CAEs) leverage convolutional neural networks (CNNs) in the encoder and decoder parts of the autoencoder. CNNs are particularly effective in capturing spatial dependencies and hierarchical features in data, making them well-suited for encoding structured data such as images or time series. In the context of the codebook-based homomorphic compression, a CAE can be trained on the quantized data. The encoder part of the CAE learns to compress the quantized data into a compact latent representation, which serves as the codeword. The decoder part learns to reconstruct the quantized data from the codeword. As an example, consider an example of using a CAE for encoding quantized sensor data. The quantized data is represented as a 2D matrix, where each row corresponds to a sensor reading, and each column represents a time step. The CAE encoder consists of convolutional layers followed by pooling layers, which gradually reduce the spatial dimensions of the input and extract meaningful features. The output of the encoder is a compact latent representation, which serves as the codeword. The CAE decoder consists of upsampling layers and convolutional layers, which reconstruct the original quantized data from the codeword.

Another form of deep learning coding includes recurrent autoencoders (RAEs). Recurrent autoencoders utilize recurrent neural networks (RNNs) in the encoder and decoder parts of the autoencoder. RNNs are well-suited for processing sequential data, such as time series or natural language, as they can capture temporal dependencies and context. In codebook-based homomorphic compression, an RAE can be used to encode quantized sequential data. The encoder part of the RAE consists of recurrent layers, such as Long Short-Term Memory (LSTM) or Gated Recurrent Unit (GRU) layers, which process the input sequence and generate a fixed-length latent representation, serving as the codeword. The decoder part of the RAE takes the codeword and reconstructs the original quantized sequence. For example, consider an example of using an RAE for encoding quantized audio data. The quantized audio signal is represented as a sequence of amplitude values. The RAE encoder consists of LSTM layers that process the input sequence and generate a fixed-length latent representation, which serves as the codeword. The RAE decoder, also consisting of LSTM layers, takes the codeword and reconstructs the original quantized audio sequence.

Another form of deep learning coding includes variational autoencoders (VAEs). Variational autoencoders extend the concept of autoencoders by introducing a probabilistic framework. VAEs learn to encode the input data into a probability distribution in the latent space, rather than a single point. The encoder part of the VAE learns to map the input data to the parameters of a probability distribution (e.g., mean and variance of a Gaussian distribution), and the decoder part learns to reconstruct the original data from samples drawn from this distribution. In codebook-based homomorphic compression, a VAE can be used to generate codewords that capture the underlying probability distribution of the quantized data. The encoder part of the VAE learns to map the quantized data to the parameters of a probability distribution in the latent space. The codewords are then obtained by sampling from this distribution. The decoder part of the VAE learns to reconstruct the original quantized data from the sampled codewords. Consider an example of using a VAE for encoding quantized image data. The quantized images are fed into the VAE encoder, which learns to map each image to the parameters of a Gaussian distribution in the latent space. The codewords are obtained by sampling from this distribution. The VAE decoder takes the sampled codewords and reconstructs the original quantized images.

Another form of deep learning coding includes deep belief networks (DBNs). Deep Belief Networks are generative models that consist of multiple layers of restricted Boltzmann machines (RBMs). DBNs can learn hierarchical representations of the input data by training each layer in an unsupervised manner, followed by fine-tuning the entire network using supervised learning. In codebook-based homomorphic compression, DBNs can be used to generate codewords that capture the hierarchical structure of the quantized data. The DBN is trained on the quantized data, and the activations of the hidden layers serve as the codewords. The hierarchical nature of DBNs allows for capturing complex patterns and dependencies in the data. Consider an example of using a DBN for encoding quantized text data. The quantized text is represented as a binary vector, where each element corresponds to the presence or absence of a specific word. The DBN is trained on the quantized text data, and the activations of the hidden layers serve as the codewords. The DBN learns to capture the hierarchical structure and semantic relationships in the text data.

These are just a few examples of deep learning encoding techniques that can be explored for creating codewords of the quantized data in the codebook-based homomorphic compression system. The choice of the specific deep learning architecture depends on the nature of the data and the desired properties of the codewords. It's important to note that the deep learning encoding process should be designed to generate codewords that are suitable for homomorphic operations. The codewords should exhibit certain properties, such as being compatible with the homomorphic encryption scheme's plaintext space and allowing for efficient homomorphic computations.

During the training process of the deep learning models, the objective function should be designed to capture the desired properties of the codewords, such as minimizing the reconstruction error while ensuring the codewords are suitable for homomorphic operations. Additionally, regularization techniques can be employed to encourage sparsity or other desirable properties in the codewords. Once the deep learning models are trained, the encoder part can be used to generate codewords for new quantized data. The generated codewords can then be used in the codebook-based homomorphic compression scheme, enabling efficient and privacy-preserving computations on the compressed data.

Experimental evaluation and performance analysis can be conducted to assess the effectiveness of the deep learning encoding techniques in generating codewords that achieve good compression ratios, maintain low approximation errors, and enable efficient homomorphic operations. The choice of the deep learning architecture and hyperparameters can be fine-tuned based on the specific requirements and characteristics of the data.

According to the aspect, a codebook library 304 is present and configured to store a plurality of codewords (i.e., a codebook) generated by one or more of the techniques described herein. When it comes to storing the codewords and codebook in the codebook-based homomorphic compression system, several database systems and data storage solutions can be considered. The choice of the storage system depends on factors such as the size of the codebook, the frequency of updates, the retrieval and query requirements, and the overall system architecture. In some implementations key-value stores may be used, Key-value stores are a type of NoSQL database that provide a simple and efficient way to store and retrieve data based on a unique key. Examples of key-value stores include Redis, Memcached, and Amazon DynamoDB. For storing the codewords and codebook, key-value stores can be used to store each codeword as a key-value pair, where the key represents the codeword, and the value represents the corresponding data or metadata associated with the codeword. The codebook can be stored as a collection of key-value pairs, allowing for fast retrieval of codewords based on their keys. Key-value stores offer high performance, low latency, and scalability, making them suitable for scenarios where fast retrieval of codewords is critical.

Document databases, such as MongoDB or Couchbase, store data as flexible, semi-structured documents in formats like JSON or BSON. They provide a schema-less design and allow for easy modification of the data structure. For storing the codewords and codebook, document databases can be used to store each codeword as a document, along with its associated data or metadata. The codebook can be stored as a collection of documents, where each document represents a codeword and its related information. Document databases offer flexibility in terms of data structure, allowing for easy addition or modification of codeword attributes. They also provide querying capabilities based on document fields, enabling efficient retrieval of codewords based on specific criteria.

Relational databases, such as MySQL, PostgreSQL, or Oracle, can also be used to store the codewords and codebook. In a relational database, the codewords can be stored in a table with columns representing the codeword and its associated data or metadata. The codebook can be stored in a separate table, with each row representing a codeword and its corresponding information. Relational databases provide structured querying capabilities using SQL, allowing for efficient retrieval and filtering of codewords based on specific conditions. Relational databases offer strong consistency, ACID properties, and support for complex queries, making them suitable for scenarios where data integrity and structured querying are important.

Graph databases, such as Neo4j or Amazon Neptune, store data as nodes and edges in a graph structure. They are designed to efficiently handle complex relationships and connections between data entities. For storing the codewords and codebook, graph databases can be used to represent the relationships between codewords and their associated data or metadata. Each codeword can be represented as a node in the graph, with edges connecting related codewords or linking codewords to their corresponding data. Graph databases provide efficient traversal and querying capabilities based on the graph structure, allowing for fast retrieval of connected codewords and exploration of relationships between codewords.

Distributed key-value stores, such as Apache Cassandra or Apache HBase, are designed to handle large-scale data and provide high scalability and fault tolerance. They distribute data across multiple nodes in a cluster, allowing for horizontal scaling. For storing the codewords and codebook, distributed key-value stores can be used to store codewords as key-value pairs, similar to regular key-value stores. The codebook can be partitioned and distributed across multiple nodes in the cluster, enabling high scalability and performance. Distributed key-value stores offer eventual consistency, high write throughput, and the ability to handle large volumes of data, making them suitable for scenarios where scalability and fault tolerance are critical.

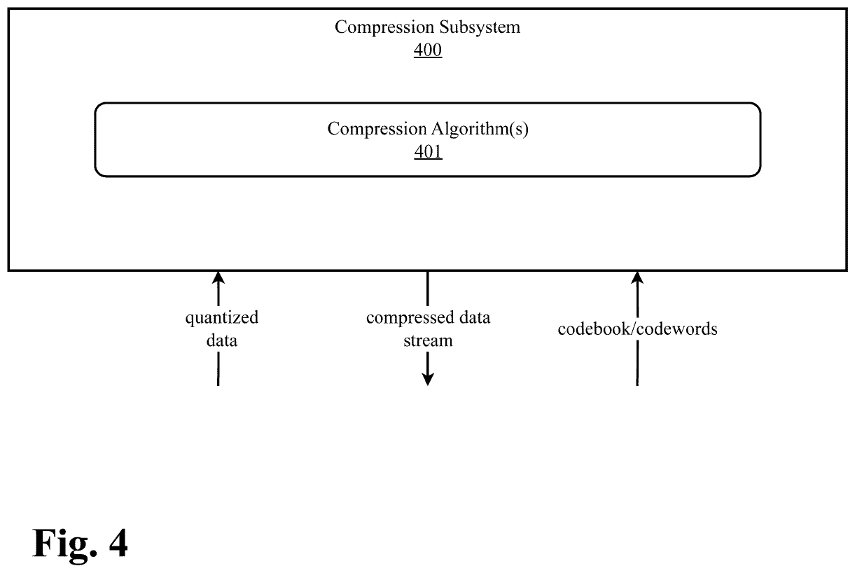

FIG. 4 is a block diagram illustrating an exemplary aspect of a system for codebook-based homomorphic encryption, a compression subsystem. According to the aspect, compression subsystem 400 is configured to perform a process of replacing each quantized data values with its corresponding code form the codebook.

According to an embodiment, the compression process may involve replacing each quantized data value with its corresponding codeword from the generated codebook. This process achieves data compression by representing the original data using a compact representation. A compression algorithm 401 traverses the quantized data and looks up the codeword for each interval in the codebook. The codewords are then concatenated to form the compressed data stream. The resulting compressed data has a reduced size compared to the original data, as the codewords are typically shorter than the original data values. The compression ratio, which is the ratio of the size of the compressed data to the size of the original data, depends on the distribution of the data and the effectiveness of the codebook. A well-designed codebook that assigns shorter codewords to more frequent intervals will result in higher compression ratios. As an example, the subsystem 400 may compress a sequence of quantized temperature values using the Huffman codebook generated in the previous example. Consider the following sequence of quantized intervals: [Interval 4, Interval 2, Interval 1, Interval 4, Interval 3, Interval 2, Interval 4]. Using the Huffman codebook, the compression algorithm can replace each interval with its corresponding codeword: [11, 00, 101, 11, 01, 00, 11]. The compressed data stream would be: 11000101110100011. The original data consisted of 7 intervals, each requiring at least 3 bits to represent (since there are 5 intervals). The compressed data stream has a length of 17 bits, achieving a compression ratio of approximately 0.81 (17 bits/21 bits).

Some exemplary compression algorithms that may be implemented in various embodiments of the system can include, but are not limited to, Huffman coding, arithmetic coding, run-length encoding (RLE), Lempel-Ziv-Welch (LZW) compression, discrete cosine transform (DCT) compression, and wavelet compression. These are just a few examples of compression algorithms that could be used in the compression process of the codebook-based homomorphic compression system. The choice of the specific compression algorithm depends on the nature of the data, the desired compression ratio, the acceptable level of information loss (if any), and the computational complexity constraints.

Run-length encoding is a simple lossless compression algorithm that replaces consecutive occurrences of the same symbol with a single instance of the symbol followed by a count of the number of occurrences. RLE is particularly effective for datasets with long runs of repeated symbols. For example, consider a quantized dataset: “AAAABBBBCCCCDDDD”. Using RLE, the compressed data would be: “A4B4C4D4”. Each symbol is replaced by the symbol itself followed by the count of consecutive occurrences.

LZW compression is a dictionary-based lossless compression algorithm that builds a dictionary of previously seen patterns in the data. It starts with a predefined dictionary containing single symbols and progressively adds new entries to the dictionary as it encounters new patterns. Each new pattern is represented by a reference to the dictionary entry, resulting in a compressed representation of the data. As an example, consider a quantized dataset: “ABABCABCDABCDE”. Using LZW compression, the dictionary would be built as follows: Dictionary: {A: 1, B: 2, C: 3, D: 4, E: 5}. The compressed data would be: “1, 2, 1, 2, 3, 1, 2, 3, 4, 1, 2, 3, 4, 5”. Each new pattern encountered is added to the dictionary, and the compressed data consists of references to the dictionary entries.

DCT compression is a lossy compression algorithm commonly used in image and video compression. It transforms the data from the spatial domain to the frequency domain using the discrete cosine transform. In the frequency domain, the high-frequency components, which often correspond to less perceptually significant information, can be discarded or quantized more aggressively, resulting in compression. For example, consider a quantized image block of size 8×8 pixels. The DCT is applied to the block, transforming it into the frequency domain. The resulting DCT coefficients are then quantized based on a predefined quantization matrix. The quantized coefficients are further compressed using entropy coding techniques like Huffman coding or arithmetic coding. The compressed data consists of the quantized DCT coefficients along with the necessary metadata for reconstruction.

Wavelet compression is another lossy compression algorithm that uses wavelet transforms to decompose the data into different frequency sub-bands. The wavelet coefficients in each sub-band are then quantized and encoded, resulting in a compressed representation. Wavelet compression is effective for compressing signals and images with localized features and discontinuities. As an example, consider a quantized 1D signal. The wavelet transform is applied to the signal, decomposing it into different frequency sub-bands. The wavelet coefficients in each sub-band are quantized based on a predefined quantization scheme. The quantized coefficients are then encoded using entropy coding techniques. The compressed data consists of the quantized wavelet coefficients along with the necessary metadata for reconstruction.

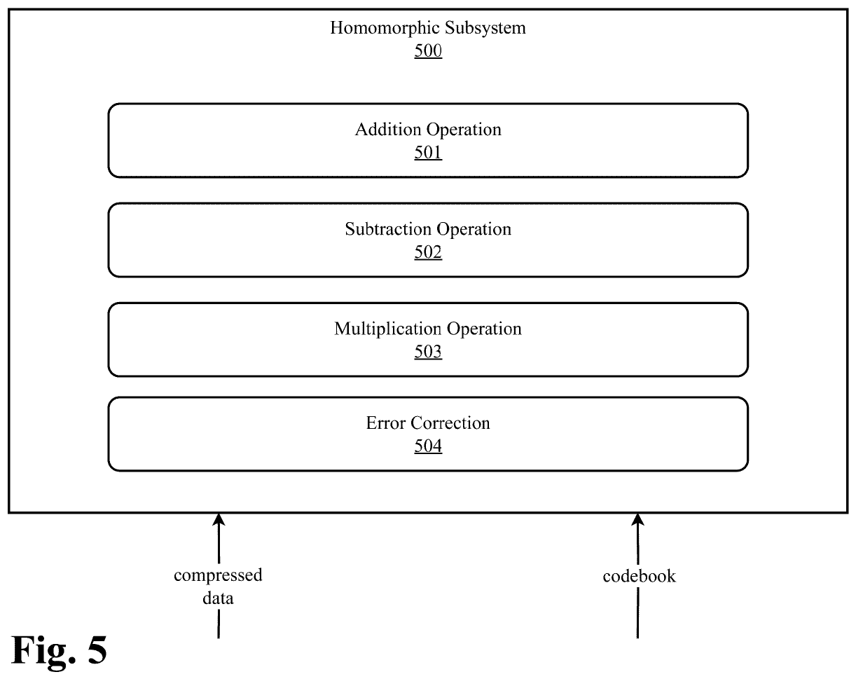

FIG. 5 is a block diagram illustrating an exemplary aspect of a system for codebook-based homomorphic encryption, a homomorphic subsystem. According to the aspect, homomorphic subsystem 500 is enables homomorphic operations (e.g., addition, subtraction, averaging, etc.) directly on the compressed data.

According to the embodiment, the codebook-based homomorphic compression system enables homomorphic operations, such as addition, subtraction, and multiplication, to be performed directly on the compressed data without the need for decompression. This property allows for efficient and privacy-preserving computations on the compressed data. To enable homomorphic operations, the system can leverage the properties of the codebook and the quantization scheme. One method is to perform the desired operation on the codewords and then map the result back to the corresponding interval in the codebook. According to an aspect, to add two compressed values, the homomorphic addition operation 501 is performed on their corresponding codewords. The result is then mapped back to the nearest interval in the codebook. For example, the subsystem adds two compressed temperature values using the Huffman codebook from the previous examples. Value 1: Interval 4 (Codeword: 11) and Value 2: Interval 2 (Codeword: 00). To perform homomorphic addition, the subsystem 500 add the corresponding codewords: 11+00=11 (binary addition). The result (11) is then mapped back to the nearest interval in the codebook, which is Interval 4. Thus, the homomorphic addition of Interval 4 and Interval 2 yields Interval 4.

According to an aspect, homomorphic subtraction 502 follows a similar process, where the codewords are subtracted, and the result is mapped back to the nearest interval in the codebook. As an example, the subsystem subtracts two compressed temperature values. Value 1: Interval 4 (Codeword: 11) and Value 2: Interval 1 (Codeword: 101). Homomorphic subtraction: 11−101=−10 (binary subtraction). The result (−10) is mapped back to the nearest interval in the codebook, which is Interval 1. Thus, the homomorphic subtraction of Interval 4 and Interval 1 yields Interval 1.

According to an aspect, homomorphic multiplication 503 comprises multiplying the codewords and mapping the result back to the nearest interval in the codebook. However, multiplication in the codeword domain may lead to a result that lies outside the range of the codebook. To handle this, the system can employ techniques such as codeword extension or scaling, according to some embodiments. For example, the subsystem multiplies two compressed temperature values. Value 1: Interval 2 (Codeword: 00) and Value 2: Interval 3 (Codeword: 01). Homomorphic multiplication: 00*01=0000 (binary multiplication). The result (0000) is mapped back to the nearest interval in the codebook, which is Interval 0. Thus, the homomorphic multiplication of Interval 2 and Interval 3 yields Interval 0. Note that homomorphic multiplication may introduce more approximation errors compared to addition and subtraction due to the limitations of the codebook range. The homomorphic operations 501-503 in the codebook-based homomorphic compression system allow for computations to be performed directly on the compressed data, eliminating the need for decompression, and enabling privacy-preserving computations. However, it's important to note that the accuracy of the homomorphic operations depends on the quantization scheme and the codebook design. In some implementations, the system may introduce approximation errors, especially for operations like multiplication, which can be mitigated through careful codebook construction and error correction techniques.

Error correction techniques 504 may be used in improving the accuracy and reliability of homomorphic operations, especially multiplication, in the codebook-based homomorphic compression system. Homomorphic multiplication often introduces higher levels of approximation errors compared to addition and subtraction due to the limitations of the codebook and the inherent properties of the encryption scheme. Some error correction techniques that could be applied to enhance the performance of homomorphic multiplication include, but are not limited to, Residue Number System (RNS), error correction codes, bootstrapping, iterative refinement, and codebook optimization.

The Residue Number System is a numerical representation system that can be used to reduce the approximation errors in homomorphic multiplication. In RNS, a number is represented by its residues modulo a set of pairwise coprime moduli. Homomorphic operations are performed independently on each residue, and the results are combined using the Chinese Remainder Theorem (CRT) to obtain the final result. The RNS representation helps to distribute the approximation errors across multiple residues, reducing the overall error in the homomorphic multiplication. By carefully selecting the moduli set and the encoding scheme, the approximation errors can be minimized, and the accuracy of homomorphic multiplication can be improved. For example, consider a numerical value x that needs to undergo homomorphic multiplication. Instead of directly operating on x, it is encoded using RNS with a set of moduli {m1, m2, m3}. The homomorphic multiplication is performed independently on each residue: x mod m1=x1, x mod m2=x2, x mod m3=x3. The homomorphic multiplication results (y1, y2, y3) are then combined using CRT to obtain the final result y. The RNS representation helps to distribute the approximation errors across the residues, reducing the overall error in the homomorphic multiplication.

Error correction codes, such as Reed-Solomon codes, Bose-Chaudhuri-Hocquenghem (BCH) codes, or Golay codes may be implemented to detect and correct errors introduced during homomorphic multiplication. These codes add redundancy to the data, enabling the detection and correction of a certain number of errors. In the context of homomorphic multiplication, the error correction codes can be applied to the codewords or the intermediate results. By encoding the codewords or results with an appropriate error correction code, the system can detect and correct errors that may arise due to the approximations introduced by the codebook and the homomorphic encryption scheme. As an example, consider a codeword c that undergoes homomorphic multiplication. Before the multiplication, the codeword is encoded using a Reed-Solomon code, adding redundancy. The encoded codeword c′ is then used in the homomorphic multiplication. After the homomorphic multiplication, the resulting codeword d′ may contain errors due to approximations. The Reed-Solomon decoder is applied to d′, detecting and correcting any errors within its error correction capability. The corrected codeword d is then obtained, improving the accuracy of the homomorphic multiplication result.

Bootstrapping is a technique used in fully homomorphic encryption (FHE) schemes to refresh the ciphertext and reduce the accumulated noise. In the context of the codebook-based homomorphic compression system, bootstrapping can be adapted to reduce the approximation errors introduced by homomorphic multiplication. The idea is to perform a homomorphic decryption followed by a homomorphic re-encryption of the intermediate result. This process helps to reduce the accumulated approximation errors and maintain the accuracy of the homomorphic multiplication. Consider a homomorphic multiplication operation, for example, that results in a ciphertext c with accumulated approximation errors. The bootstrapping process is applied to c as follows: homomorphically decrypt c to obtain the intermediate plaintext result p; apply error correction techniques (e.g., rounding, truncation) to p to reduce the approximation errors; and Homomorphically re-encrypt the corrected plaintext p′ to obtain a refreshed ciphertext c′. The refreshed ciphertext c′ has reduced approximation errors, improving the accuracy of the homomorphic multiplication result.

Iterative refinement is a technique that can be used to improve the accuracy of homomorphic multiplication by iteratively refining the result. The idea is to perform the homomorphic multiplication multiple times, each time using the previous result as input and applying error correction techniques to reduce the approximation errors. Consider a homomorphic multiplication operation, for example, between ciphertexts a and b. The iterative refinement process can be applied as follows: perform the homomorphic multiplication to obtain the initial result c1=a*b; apply error correction techniques (e.g., rounding, truncation) to c1 to obtain a corrected result c1; use c1′ as input for the next iteration, performing the homomorphic multiplication again: c2=c1′*b; and repeat steps 2-3 for a fixed number of iterations or until a desired level of accuracy is achieved. Each iteration helps to refine the result and reduce the approximation errors, improving the accuracy of the homomorphic multiplication.

The design and optimization of the codebook used in the homomorphic compression system can also contribute to reducing approximation errors in homomorphic multiplication. By carefully constructing the codebook and selecting the codewords, the system can minimize the impact of approximations on the multiplication results. Techniques such as vector quantization, lattice-based codebooks, or learning-based codebook generation can be implemented to create codebooks that are more resilient to approximation errors and provide better accuracy in homomorphic multiplication. For example, consider a codebook optimization technique that aims to minimize the approximation errors in homomorphic multiplication. The codebook may be constructed using a learning-based approach, where a neural network is trained to generate codewords that minimize the approximation errors when multiplied homomorphically. The training process may comprise multiplying codewords homomorphically and comparing the results with the actual multiplication results. The neural network is optimized to generate codewords that minimize the difference between the homomorphic multiplication results and the actual results. The resulting codebook is more resilient to approximation errors and provides improved accuracy in homomorphic multiplication.

These error correction techniques 504 can be applied individually or in combination to enhance the accuracy and reliability of homomorphic operations in the codebook-based homomorphic compression system. The specific choice of techniques depends on the characteristics of the data, the desired level of accuracy, and the computational constraints of the system.

### Detailed Description of Exemplary Aspects

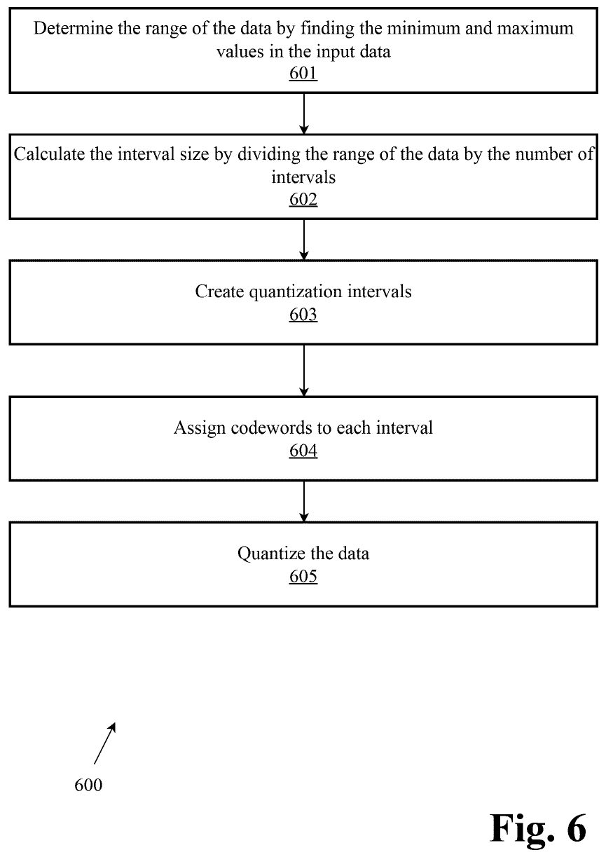

FIG. 6 is a flow diagram illustrating an exemplary method for performing data quantization on input data, according to an aspect. According to the aspect, the quantization method takes the input data and the desired number of quantization intervals as parameters. It begins at step 601 by determining the range of the data by finding the minimum and maximum values in the input data. Then, at step 602 it calculates the interval size by dividing the range of the data by the number of intervals, ensuring that the intervals are of equal size. As a next step 603, the process creates the quantization intervals. Each interval is represented as a tuple containing the starting value and the ending value of the interval. The intervals are stored in a list. After that, the method assigns codewords to each interval at step 604. In this example, the codewords are simply integers ranging from 0 to the number of intervals minus 1. The codewords are stored in a separate list. The method then proceeds to quantize the data at step 605. It iterates over each value in the input data and finds the corresponding interval it belongs to. It assigns the codeword of the matching interval to the quantized data. If a value falls outside the range of the intervals, the method assigns the codeword of the last interval. Finally, the method returns three outputs: the quantized representation of the input data, the list of quantization intervals, and the list of assigned codewords.

To use the quantization method, the system (or a user) can provide the input data and the desired number of quantization intervals. The method will return the quantized data, along with the quantization intervals and codewords, which can be used for further processing or analysis. For example, if you have input data [0.2, 0.5, 0.8, 1.2, 1.5, 1.8, 2.2, 2.5] and you want to quantize it into 4 intervals, the system can call the quantization method with these parameters. The method will quantize the data and return the quantized representation [0, 1, 1, 2, 2, 3, 3, 3], along with the quantization intervals [(0.2, 0.7), (0.7, 1.2), (1.2, 1.7), (1.7, 2.2)] and the codewords [0, 1, 2, 3].

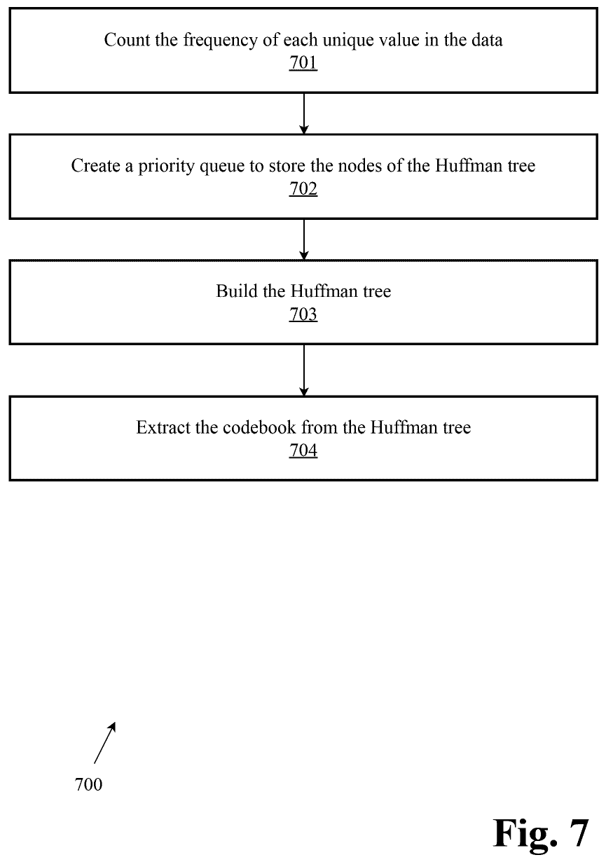

FIG. 7 is a flow diagram illustrating an exemplary method for performing codebook generation using Huffman coding, according to an aspect. According to the aspect, the codebook generation method takes the input data as a parameter. It begins at step 701 by counting the frequency of each unique value in the data using a frequency counter. This step creates a dictionary where the keys are the unique values, and the values are their corresponding frequencies. As a next step 702, the method creates a priority queue to store the nodes of the Huffman tree. Each node is represented as a list containing the frequency and the symbol-code pair. The symbol-code pair consists of the unique value and an empty string as a placeholder for the Huffman code. The priority queue is initialized with the frequency-symbol pairs and heapified to maintain the priority order based on the frequencies. The process then proceeds to build the Huffman tree at step 703. It repeatedly extracts the two nodes with the lowest frequencies from the priority queue. It assigns the code ‘0’ to the symbols in the left node and ‘1’ to the symbols in the right node. The frequencies of the left and right nodes are combined, and a new node is created with the combined frequencies and the updated symbol-code pairs. The new node is pushed back into the priority queue. This process continues until there is only one node left in the priority queue, representing the root of the Huffman tree. At this point, the Huffman tree is complete, and each symbol has been assigned a unique Huffman code. As a last step 704, the method extracts the codebook from the Huffman tree. It traverses the remaining node in the priority queue and creates a dictionary where the keys are the unique values, and the values are their corresponding Huffman codes. The codebook represents the mapping between the symbols and their assigned codes. The generated codebook is then returned as the output of the method.

To use the codebook generation method, the system (or a user) can provide the input data as a parameter. The method will process the data, build the Huffman tree, and generate the codebook based on the frequency distribution of the symbols. The resulting codebook assigns shorter codes to more frequent symbols and longer codes to less frequent symbols, achieving efficient compression. For example, if the input data comprises [0, 1, 1, 2, 2, 2, 3, 3, 3, 3], the system can call the codebook generation method with this data. The method will generate a codebook that maps each unique value to its corresponding Huffman code. In this case, the codebook may look something like:
0: 000
1: 001
2: 01
3: 1

The generated codebook can then be used to compress the input data by replacing each symbol with its corresponding Huffman code, resulting in a compressed representation of the data.

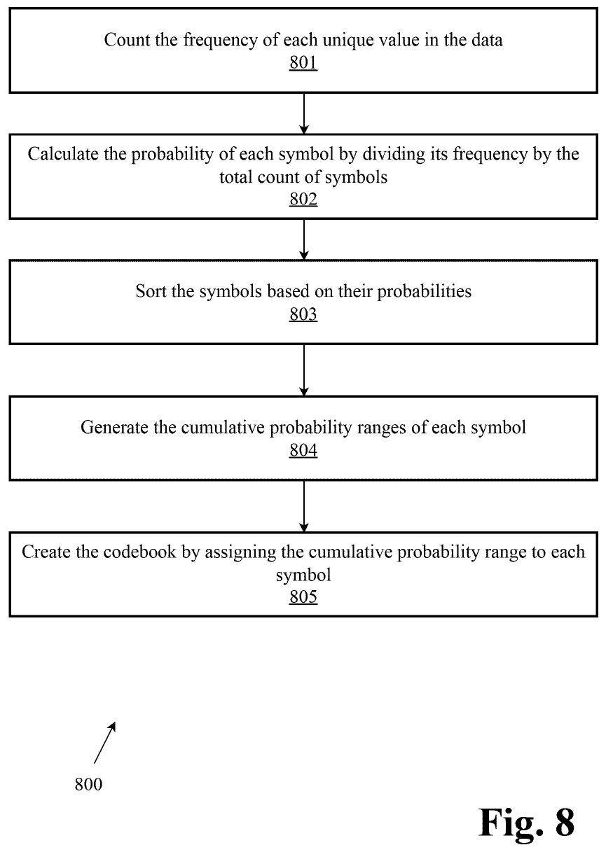

FIG. 8 is a flow diagram illustrating an exemplary method for performing codebook generation using arithmetic coding, according to an aspect. According to the aspect, the codebook generation method using arithmetic coding takes the input data as a parameter. It begins at step 801 by counting the frequency of each unique value in the data using a frequency counter. This step creates a dictionary where the keys are the unique symbols, and the values are their corresponding frequencies. As a next step 802, the method calculates the probability of each symbol by dividing its frequency by the total count of symbols in the data. The probabilities may be stored in a dictionary where the keys are the symbols, and the values are their corresponding probabilities. The method then sorts the symbols based on their probabilities in ascending order at step 803. This step ensures that the symbols are arranged in increasing order of their probabilities, which is necessary for generating the cumulative probability ranges. After sorting the symbols, the method generates the cumulative probability ranges for each symbol at step 804. It iterates over the sorted symbols and calculates the cumulative probability range for each symbol. The cumulative probability range represents the interval [lower_bound, upper_bound) assigned to each symbol based on its probability. The lower bound of the range is the cumulative probability of all the symbols preceding the current symbol, and the upper bound is the cumulative probability up to and including the current symbol. The cumulative ranges may be stored in a dictionary where the keys are the symbols, and the values are their corresponding cumulative probability ranges. As a last step 805, the method creates the codebook by assigning the cumulative probability range to each symbol. The codebook is represented as a dictionary where the keys are the symbols, and the values are their corresponding cumulative probability ranges. The generated codebook is then returned as the output of the method.

To use the codebook generation method with arithmetic coding, the system (or a user) can provide the input data as a parameter. The method will process the data, calculate the probabilities of each symbol, sort the symbols based on their probabilities, generate the cumulative probability ranges, and create the codebook. The resulting codebook assigns a cumulative probability range to each symbol based on its probability of occurrence in the data. The generated codebook can then be used to compress the input data using arithmetic coding. The compression process comprises recursively subdividing the interval [0, 1) based on the probabilities of the symbols, and the final compressed code is a single fraction that lies within the subinterval corresponding to the entire sequence of symbols.

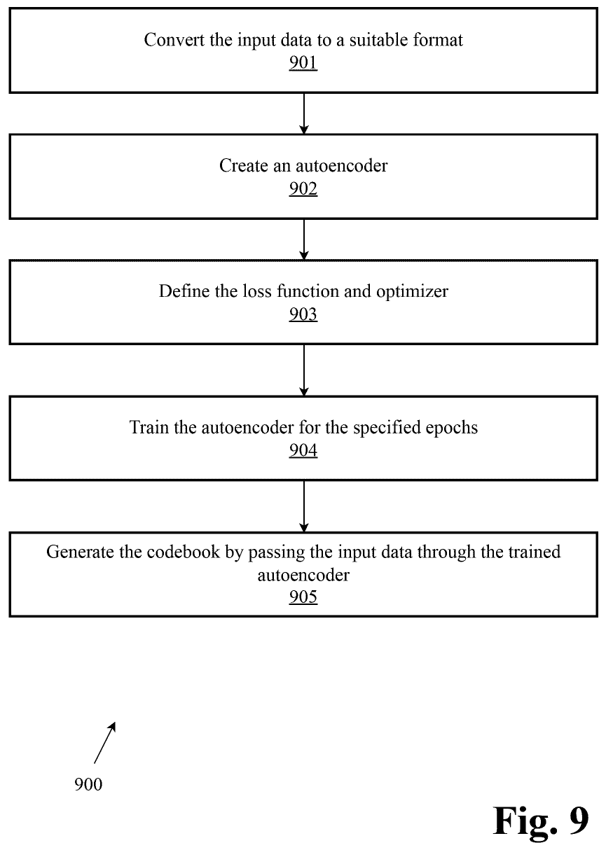

FIG. 9 is a flow diagram illustrating an exemplary method for performing codebook generation using a deep learning model, according to an aspect. According to the aspect, the codebook generation method using deep learning takes the input data, desired codebook size, number of training epochs, and learning rate as parameters. It begins at step 901 by preparing the data by converting it into a suitable format, such as a PyTorch tensor, to be used as input to the deep learning model. Next, the method creates an autoencoder model at step 902, which consists of an encoder and a decoder. The encoder is responsible for mapping the input data to a lower-dimensional codebook space, while the decoder reconstructs the original data from the codebook representation. The architecture of the autoencoder can be adjusted based on the specific requirements of the problem, such as the input dimensionality, hidden layer sizes, and activation functions. The method then defines the loss function and optimizer for training the autoencoder at step 903. Common choices for the loss function include Mean Squared Error (MSE) or Mean Absolute Error (MAE), which measure the reconstruction error between the original data and the reconstructed data. The optimizer, such as Adam or Stochastic Gradient Descent (SGD), is used to update the model parameters during training.

At step 904 the autoencoder is trained for the specified number of epochs. In each epoch, the method performs a forward pass through the autoencoder, passing the input data through the encoder to obtain the codebook representation and then through the decoder to reconstruct the original data. The reconstruction loss is calculated using the chosen loss function, and a backward pass is performed to compute the gradients of the loss with respect to the model parameters. The optimizer is then used to update the model parameters based on the gradients, with the goal of minimizing the reconstruction loss. During training, the method can print the loss at regular intervals (e.g., every 100 epochs) to monitor the progress and convergence of the autoencoder. The training process aims to find the optimal set of parameters that minimize the reconstruction error, effectively learning a compact and meaningful codebook representation of the input data.

After training, the process generates the codebook by passing the input data through the trained encoder at step 905. The output of the encoder represents the codebook, where each data point is mapped to a lower-dimensional representation in the codebook space. The generated codebook captures the essential features and patterns in the input data, enabling efficient compression and reconstruction. The codebook generation method using deep learning offers a powerful and flexible approach to learn a compact and meaningful representation of the data. By leveraging the capabilities of deep neural networks, such as autoencoders, the method can automatically discover and extract relevant features from the input data, resulting in a codebook that captures the underlying structure and patterns.

The autoencoder-based approach has several advantages. It can handle high-dimensional and complex data, learn non-linear transformations, and adapt to various data types and distributions. Additionally, the autoencoder can be trained in an unsupervised manner, without requiring labeled data, making it applicable to a wide range of datasets and domains.

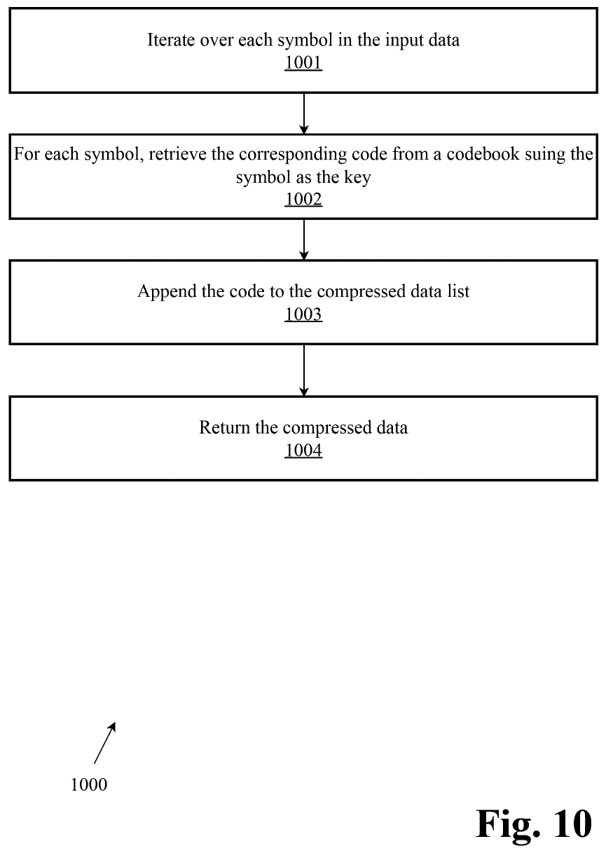

FIG. 10 is a flow diagram illustrating an exemplary method for performing compression using the generation codebooks, according to an aspect. According to the aspect, the compression method takes the input data and the generated codebook as parameters. The codebook is a mapping that associates each unique symbol in the input data with a corresponding code. The purpose of the compression method is to replace each symbol in the input data with its corresponding code from the codebook, resulting in a compressed representation of the data. The process begins at step 1001 by initializing an empty list called “compressed_data” to store the compressed representation of the input data. It then iterates over each symbol in the input data, one symbol at a time. For each symbol, the method retrieves the corresponding code from the codebook using the symbol as the key at step 1002. The codebook may be implemented as a dictionary or a hash map, allowing for efficient lookup of codes based on the symbols. At step 1003, once the code for a symbol is retrieved, it is appended to the “compressed_data” list. This process is repeated for each symbol in the input data until all symbols have been processed. After iterating over all the symbols, the “compressed_data” list contains the compressed representation of the input data, where each symbol has been replaced by its corresponding code from the codebook. As a last step 1004, the method returns the “compressed_data” list as the output, representing the compressed version of the input data.

The compression method achieves data compression by replacing the symbols in the input data with shorter codes, effectively reducing the size of the data. The effectiveness of the compression depends on the quality of the codebook and the distribution of symbols in the input data. A well-designed codebook assigns shorter codes to frequently occurring symbols and longer codes to less frequent symbols, resulting in a more compact representation of the data. The compressed data can be stored or transmitted more efficiently due to its reduced size. However, to reconstruct the original data from the compressed representation, a decompression step is necessary. Decompression involves mapping the codes back to their corresponding symbols using the same codebook used during compression.

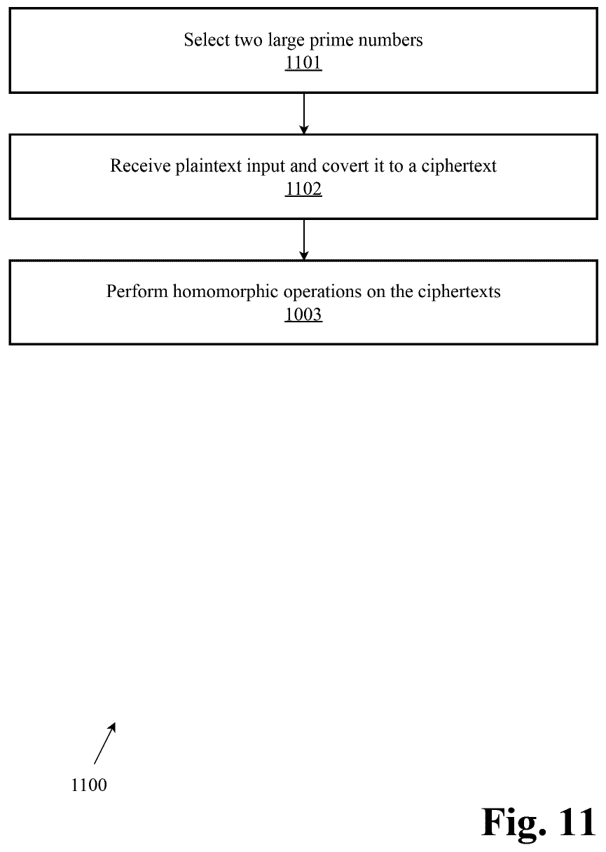

FIG. 11 is a flow diagram illustrating an exemplary method for performing homomorphic encryption using the Paillier cryptosystem, according to an aspect. According to the aspect, the homomorphic encryption method uses the Paillier cryptosystem, which allows computations to be performed on encrypted data without decrypting it first. The Paillier cryptosystem is based on the properties of modular arithmetic and relies on the difficulty of the decisional composite residuosity assumption. The homomorphic encryption scheme, such as the Paillier cryptosystem, can be implemented with the codebook-based compressed data. The idea is to encrypt the compressed data using the homomorphic encryption scheme, allowing computations to be performed on the encrypted compressed data without decrypting it first.

To begin, the Paillier cryptosystem requires the selection of two large prime numbers, p and q, which form the basis of the encryption scheme at step 1101. These prime numbers are used to compute the public key n as the product of p and q, and the private key 1 as (p−1)*(q−1). Additionally, a generator g is chosen, typically set to n+1. The encryption process takes a plaintext message as input and converts it into a ciphertext at step 1102. To encrypt a message using the Paillier cryptosystem, a random value r is generated between 1 and n−1. The ciphertext c is then computed using the formula: c=(g\hat{ }message*r\hat{ }n) mod n\hat{ }2. This encryption process ensures that the ciphertext is indistinguishable from random values and provides semantic security.

To decrypt a ciphertext and retrieve the original plaintext message, the private key 1 and a precomputed value mu (the modular multiplicative inverse of 1 modulo n) are used. The decryption formula is: m=((ciphertext\hat{ }l mod n\hat{ }2)−1)/n*mu mod n. This process reverts the encryption operation and recovers the original plaintext message.

One of the key features of the Paillier cryptosystem is its homomorphic properties, which allow computations to be performed on encrypted data. The scheme supports homomorphic addition and multiplication.

At step 1103, the system performs homomorphic operations on the ciphertext data. To perform homomorphic addition, two ciphertexts “ciphertext1” and “ciphertext2” can be multiplied modulo n\hat{ }2. The resulting ciphertext, when decrypted, will correspond to the sum of the original plaintext messages. This property allows the addition of encrypted values without revealing the individual values.

Homomorphic multiplication, on the other hand, involves raising a ciphertext “ciphertext” to the power of a plaintext “plaintext” modulo n\hat{ }2. The resulting ciphertext, when decrypted, will correspond to the product of the original plaintext message and the plaintext value used in the multiplication. This property enables the multiplication of an encrypted value by a known plaintext value.

To use the Paillier cryptosystem for homomorphic encryption, an instance of the cryptosystem is created with the chosen prime numbers p and q. Messages can then be encrypted using the “encrypt” method, producing ciphertexts. Homomorphic operations, such as addition and multiplication, can be performed on the ciphertexts using the corresponding methods provided by the cryptosystem.

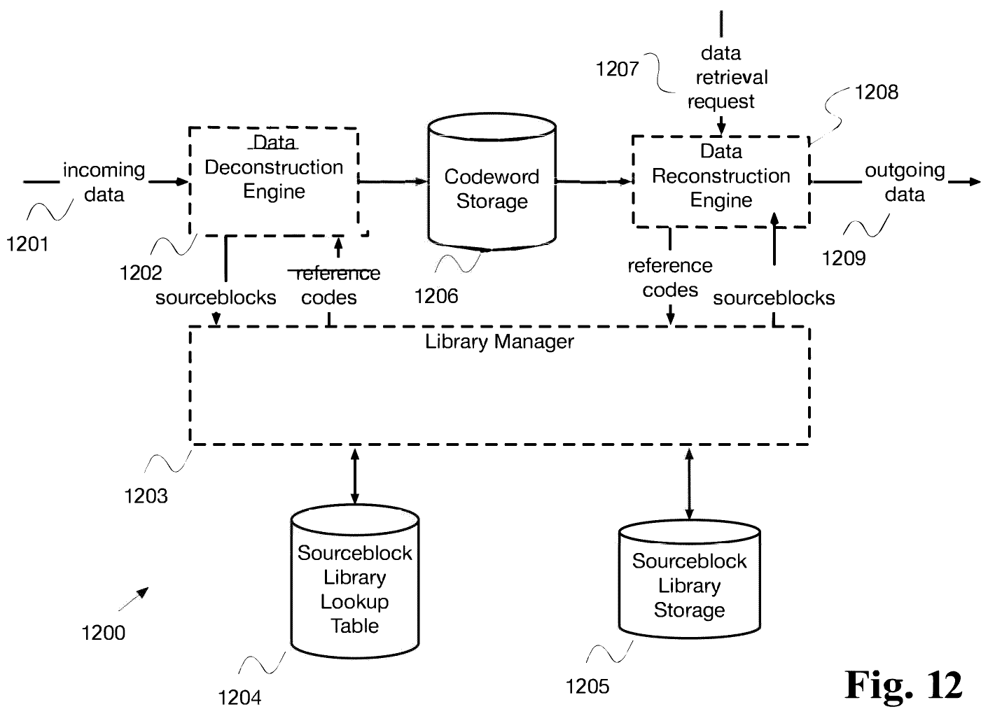

FIG. 12 is a diagram showing an embodiment 1200 of the system in which all components of the system are operated locally. As incoming data 1201 is received by data deconstruction engine 1202. Data deconstruction engine 1202 breaks the incoming data into sourceblocks, which are then sent to library manager 1203. Using the information contained in sourceblock library lookup table 1204 and sourceblock library storage 1205, library manager 1203 returns reference codes to data deconstruction engine 1202 for processing into codewords, which are stored in codeword storage 1206. When a data retrieval request 1207 is received, data reconstruction engine 1208 obtains the codewords associated with the data from codeword storage 1206, and sends them to library manager 1203. Library manager 1203 returns the appropriate sourceblocks to data reconstruction engine 1208, which assembles them into the proper order and sends out the data in its original form 1209.

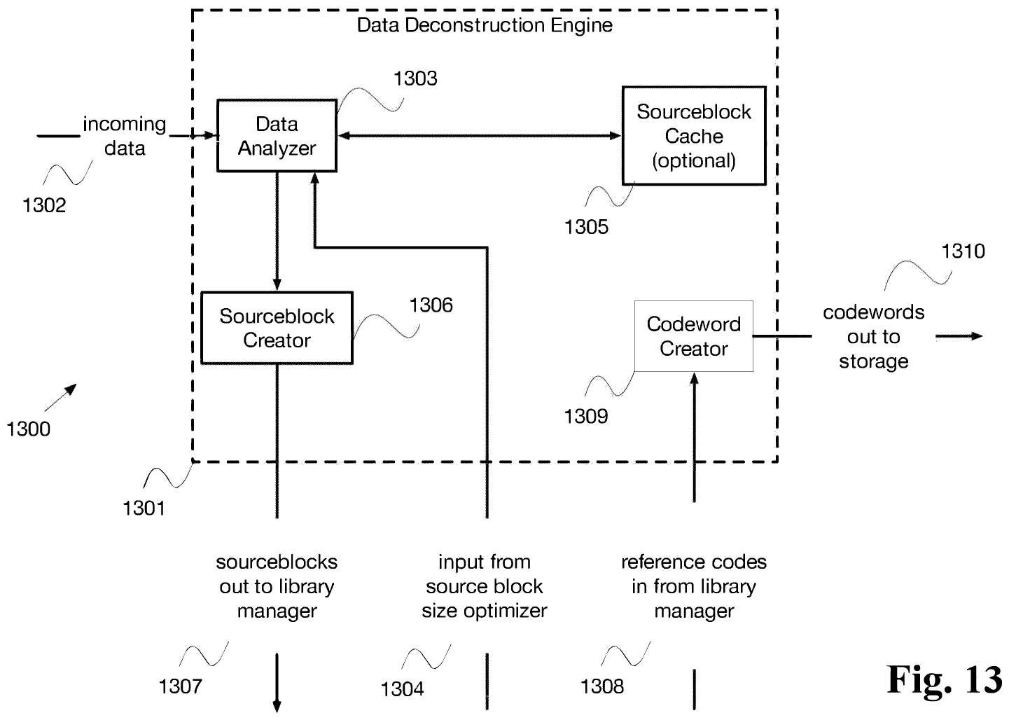

FIG. 13 is a diagram showing an embodiment of one aspect 1300 of the system, specifically data deconstruction engine 1301. Incoming data 1302 is received by data analyzer 1303, which optimally analyzes the data based on machine learning algorithms and input 1304 from a sourceblock size optimizer, which is disclosed below. Data analyzer may optionally have access to a sourceblock cache 1305 of recently-processed sourceblocks, which can increase the speed of the system by avoiding processing in library manager 103. Based on information from data analyzer 1303, the data is broken into sourceblocks by sourceblock creator 1306, which sends sourceblocks 1307 to library manager 1303 for additional processing. Data deconstruction engine 1301 receives reference codes 1308 from library manager 1203, corresponding to the sourceblocks in the library that match the sourceblocks sent by sourceblock creator 1306, and codeword creator 1309 processes the reference codes into codewords comprising a reference code to a sourceblock and a location of that sourceblock within the data set. The original data may be discarded, and the codewords representing the data are sent out to storage 1310.

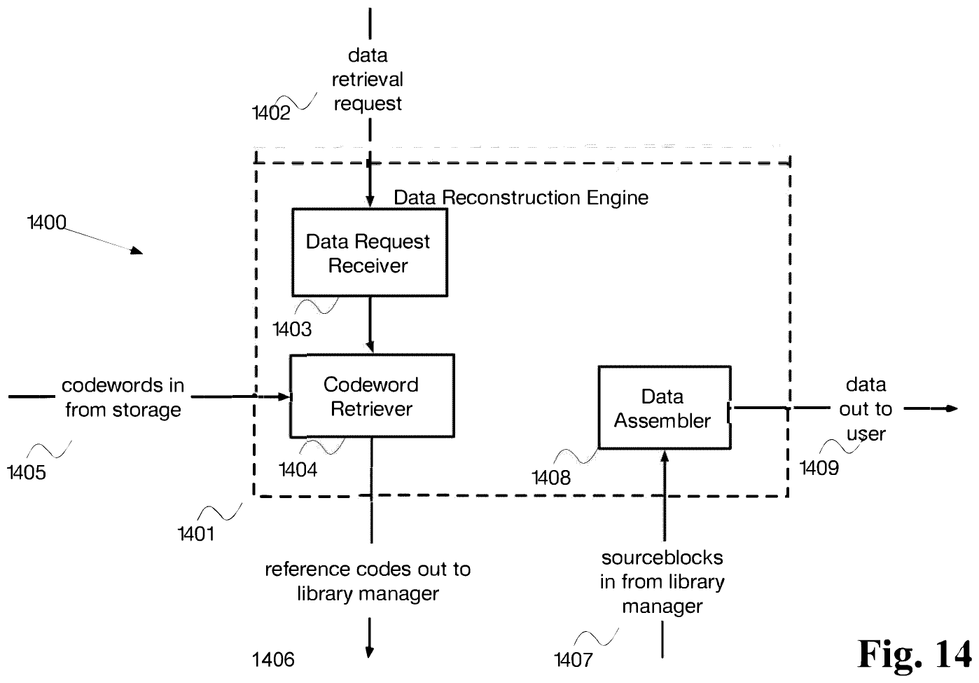

FIG. 14 is a diagram showing an embodiment of another aspect of system 1400, specifically data reconstruction engine 1401. When a data retrieval request 1402 is received by data request receiver 1403 (in the form of a plurality of codewords corresponding to a desired final data set), it passes the information to data retriever 1404, which obtains the requested data 1405 from storage. Data retriever 1404 sends, for each codeword received, a reference codes from the codeword 1406 to library manager 1203 for retrieval of the specific sourceblock associated with the reference code. Data assembler 1408 receives the sourceblock 1407 from library manager 1203 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 1409 in its original form.

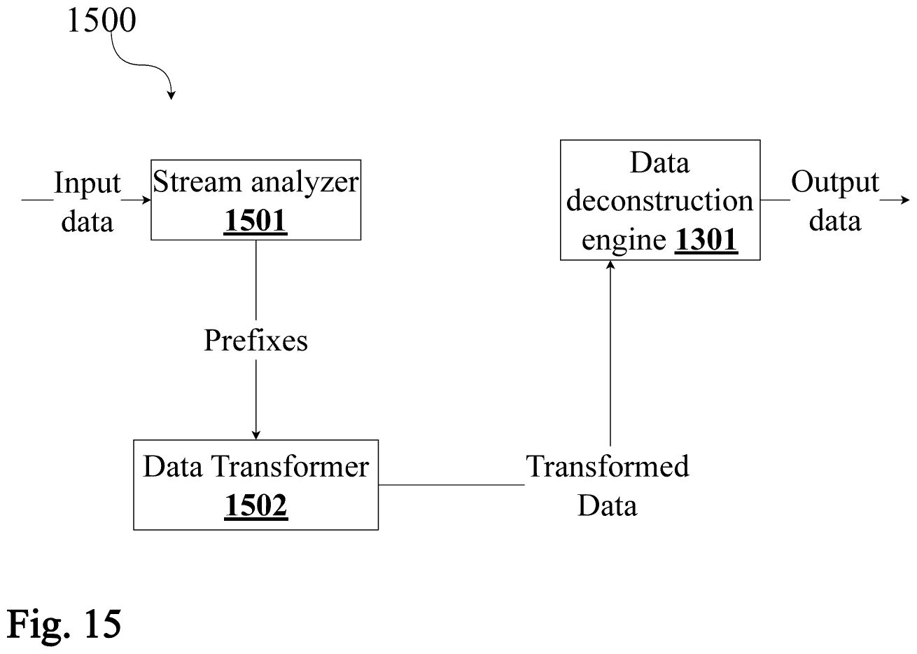

FIG. 15 is a block diagram illustrating an exemplary system 1500 architecture for combining data compression with genomic encryption techniques. According to the embodiment, an incoming data stream can be compressed and encrypted simultaneously through the use of prefix tables and the Burrows-Wheeler transform (BWT), wherein the data stream is broken into blocks (e.g., data strings) that are analyzed to identify all prefixes of the data block to determine their frequency distribution within the received data stream. BWT works provably well at transforming data into a more compressible format using a reversible and processing time efficient algorithm. A stream analyzer 1501 is present and configured to receive an input data stream and break the data stream into data blocks (e.g., sourceblocks, data strings). The data stream and resulting data blocks may be associated with a closed domain where only a limited set of data may be admitted into a data set. For example, text data where the only data admitted are text characters (e.g., American Standard Code for Information Interchange (ASCII) characters) represents a closed domain. In another example, a data domain for genetic information may be the closed set of adenine, thymine, guanin, and cytosine, commonly denoted as A, T, G, and C, wherein the four elements represent a closed domain.

According to the embodiment, stream analyzer 1501 is configured to perform frequency analysis on the input data stream by analyzing a plurality of data blocks which the input data stream comprises. Each data block is analyzed to identify and designate one or more possible prefixes that can be associated with that data block. In some aspects, a data cache is present which can temporarily store identified prefixes so that stream analyzer 1501 can quickly compare identified prefixes with those stored in the cache to determine if the prefix is unique or not. In some embodiments, the identified prefixes are bytes or strings of bytes that occur at the beginning of each of the plurality of data blocks associated with the input data stream. As each data block is analyzed, stream analyzer 1501 keep count of the total amount of times each prefix occurs and also the total prefix count for an input data stream. Using at least this information stream analyzer 1501 is able to generate a frequency distribution which can be used to identify the most-common to least-common prefixes. Once the data stream has been analyzed, the data blocks rotated, and all prefixes identified and designated, stream analyzer 1501 can compile a prefix table of results. The prefix table may comprise a list of all designated prefixes and their length (e.g., 8-bits, 16-bits, 10 genetic letters, etc.). In an example, the prefix table may order the information contained therein from most-common to least-common prefixes. In some implementations, the prefix table comprises the prefixes and block lengths, but not the full block contents.

Once a data block has been analyzed and one or more prefixes identified, the data remaining for each block that was not part of the identified prefix may be broken into one or more chunks with a pointer or offset which indicates which prefix each chunk is associated with. The chunks may be sent directly to data deconstruction engine 1301 for deconstruction into codewords as described below in greater detail (with reference to FIG. 13). The identified prefix data (e.g., in the form of a prefix table) may be sent to a data transformer 1502.

The determined prefixes based on the determined frequency distribution may then be sent data transformer 1502 which is configured to transform the received prefixes from stream analyzer 1501 and to apply one or more data transformations to each prefix to encrypt it and/or put it into a format more readily compressible, according to the embodiment. According to an aspect, data transformer 1502 may apply a Burrow's-Wheeler transform to the received data. For example, data transformer 1502 may receive prefix data and pass it through a BWT algorithm which produces as output a BWT-prefix which can be easily reversed to produce the original prefix.

Each data block of the data stream may be passed through a modified BWT algorithm to prepare the data stream for data compaction. The Burrows-Wheeler transform is a reversible algorithm used to prepare data for use with data compression techniques. Technically, BWT is a lexicographical reversible permutation of the characters of a string. An important application of BWT is found in biological sciences where genomes (long strings written in A, C, T, G alphabets) do not have many runs but they do have many repeats. The idea of the BWT is to build an array whose rows are all cyclic shifts of the input string in dictionary order and return the last column of the array that tends to have long runs of identical characters. One benefit of this is that once the characters have been clustered together, they effectively have an ordering, which can make the string more compressible for other algorithms such as Huffman coding. The last column is selected because it has better symbol clustering than any other columns and because the last column is the only column from which the original string of characters can be recovered.

When a data string (e.g., data block, character string) is transformed by BWT, the transformation permutes the order of the characters. If the original data string had several substrings that occurred often, then the transformed string will have several places where a single character is repeated multiple times in a row. The output is easier to compress because it has many repeated characters. In different implementations, variations of the BWT may be applied such as, for example, prefix-based BWT. Generally, the transform is done by sorting all the circular shifts of a text in lexicographic order and by extracting the last column and the index of the original string in the set of sorted permutations. Among the benefits of implementing BWT with disclosed data compaction techniques is that the transform is completely reversible, allowing the original data stream to be re-generated from the last column of data.

When implementing the BWT, character rotation is applied to each data block. The BWT can iterate through all possible characters to identify all prefixes using each possible match. In some implementations, the data stream may comprise genomic information and the data blocks may represent k-mers, wherein k-mers are substrings of length k contained within a biological sequence. Usually, the term k-mer refers to all of a sequence's subsequences of length k, such that the sequence ATAG would have four monomers (A, T, A, and G), three 2-mers (AT, TA, and AG), two 3-mers (ATA and TAG) and one 4-mer (ATAG). More generally, a sequence of length L will have L−k+1 k-mers and n^{k} total possible k-mers, where n is the number of possible monomers (e.g., four in the case of DNA). Prefixes in k-mers are genetic segments; base pairs that occur at the beginning of each k-mer. In the present invention, the identified prefixes are bytes or strings of bytes that occur at the beginning of data blocks (i.e., sourceblocks) and may be selected based on frequency distribution.

In some implementations, stream analyzer 1501 is configured to apply character rotations to each data block of the received input data stream and apply frequency analysis to the rotations of each data block of the data stream.

In some implementations, k-mers and reference strings (also referred to herein as reference stream) may be used to further improve compression efficiency and reduce the amount of computational resources required to encrypt/decrypt a received data stream. Generally, reference-based compression algorithms can obtain better compression ratio than general purpose and reference-free compression algorithms. Data blocks based on prefixes are analogous to genomic k-mers. However, for reference-based compression algorithms, the choice of the reference string will directly influence the performance and stability of the algorithm. A reference string may be an unencrypted data stream selected or generated by the system. In some aspects, the reference string may be a reference genome. In some implementations, the selection of the reference string may be conducted in a random or pseudorandom process, so as to avoid the risk of reverse-engineering the encrypted/compressed data based on similarity. In other implementations, the reference stream may be based on and may comprise one or more prefixes from the prefix table. As a simple illustrative example, the ten (or twenty, or one hundred, etc.) most-common prefixes may be aggregated together to form a reference stream. Further, a prefix table may be used to analyze reference strings and map blocks from the input stream. For example, a data block is received by stream analyzer 5101 and a prefix is determined for that data block, or a prefix table may be used to compare identified prefixes with prefixes that already exist in the prefix table. The prefix table and data block may be sent to data transformer 1502 which compares the data block and/or prefix with a reference stream (e.g., reference string, reference genome, etc.) in order to map the data blocks from the input data stream to the reference stream by identifying prefixes that exist within the reference stream. In some implementations, the system 1500 can locate occurrences of data blocks from the input stream within the reference stream and generate a list of location markers (i.e., location codes) for the blocks. System 1500 may be further configured to append the location markers to a delta stream. In this case, the prefix table and the delta stream are sufficient to reconstruct the data from the reference stream. This process has some advantages such as high compression, wherein only prefixes and location markers are sent (not full blocks). Likewise, the process is advantageous in that if provides high encryption, wherein the only bulk data in use is the randomly-generated reference stream which has no implicit correlation to the input stream.

The gene sequencing data compression system and methods disclosed herein are capable of effectively improving the compression ratio of the gene sequencing data, and has the advantages of low compression ratio, short compression time, and stable compression performance.

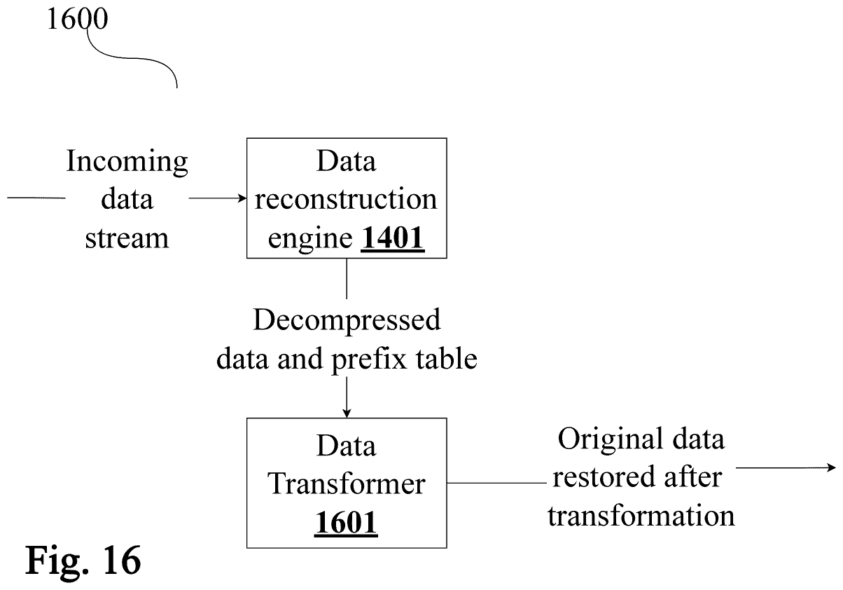

FIG. 16 is a block diagram illustrating an exemplary system architecture 1600 for decompressing and decrypting incoming data that was processed using prefix tables and BWT. To decompress and decrypt received data, a data reconstruction engine 1401 may first be used to reverse the compression on a data stream as described below in FIG. 14, passing the decompressed (but still encrypted) data to a data transformer 1601. The corresponding prefix table may be separated from the data stream (for example, the two streams may have been combined during compression but during decompression they are separated) or it may be received independently as a second data stream. Data transformer 1601 uses the prefix lengths for each BWT-prefix and applies the reversible BWT algorithm to restore the prefix table to its original format and then uses the prefix table on the decompressed and decrypted data to restore the original data on a block-by-block basis.

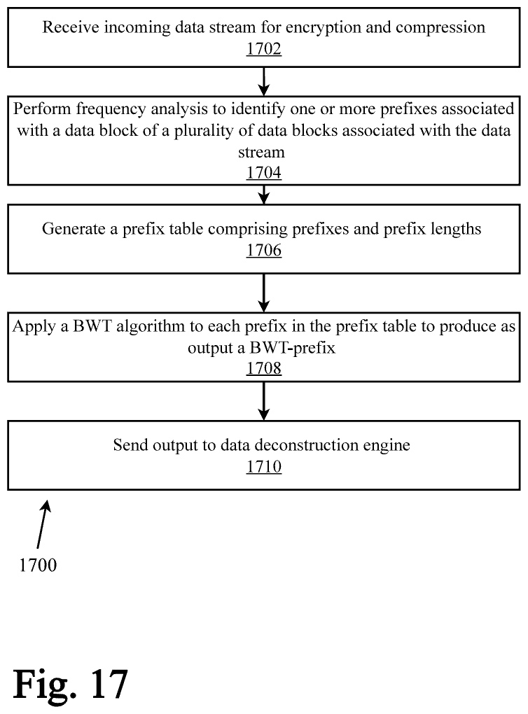

FIG. 17 is a flow diagram illustrating an exemplary method 1700 for compressing and encrypting data using prefix tables and BWT. In an initial step 1702, a data stream is received for compression and encryption. Each block in the data stream may be analyzed to identify one or more prefixes that are associated with the block and a frequency distribution of the prefixes is produced at step 1704. The most common bytes or strings of bytes that occur at the start of each block may be designated as prefixes and stream analyzer 1501 can generate a prefix table comprising prefixes and prefix lengths at step 1706. As a next step 1708, each prefix in the prefix table is then processed by a BWT algorithm to produce as output a BWT-prefix. A BWT-prefix is a highly more compressible format for a prefix, wherein the prefix is already acting a mechanism to improve the compressibility of the input data stream, which improves the efficiency of the compression and encryption mechanisms of the data deconstruction engine 1301. As a last step 1710, data transformer 1502 may send the prefix table with BWT-prefixes and their lengths as output to the data deconstruction engine 201 for compression as described in further detail below.

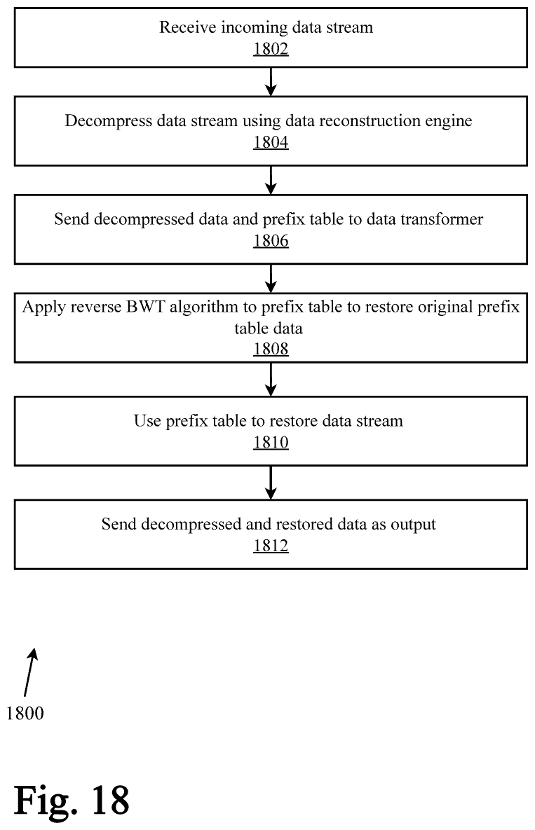

FIG. 18 is a flow diagram illustrating an exemplary method 1800 for decrypting and decompressing genomic data using prefix tables and BWT. In an initial step 1802, a data stream is received at a data reconstruction engine 1401. The data stream is decompressed 1804 by reversing the encoding as described below, and the decompressed (but still encrypted) data and prefix table are passed 1806 to a data transformer 1601. The data transformer 1601 performs a reverse BWT algorithm which restores the BWT-prefixes to their original prefix table form at step 1808. Data transformer 1601 may then use the prefix table and decompressed data to restore the original data stream 1810 which may then be sent as output to an appropriate endpoint 1812.

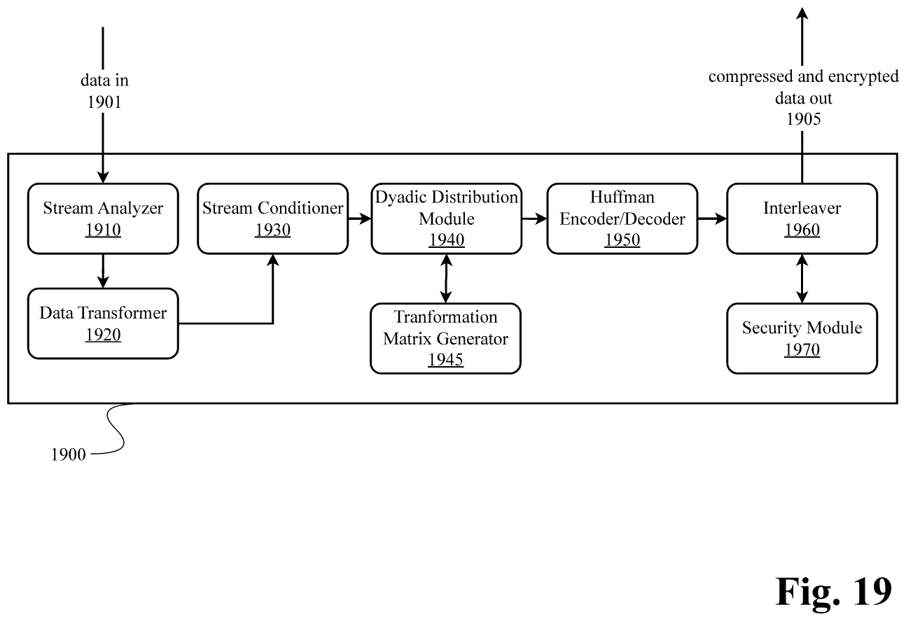

FIG. 19 is a block diagram illustrating an exemplary system architecture for a dyadic distribution-based compression and encryption platform 1900, according to an embodiment.

According to the embodiment, the platform 1900 comprises a stream analyzer 1910 which receives, retrieves, or otherwise obtains an input data stream 1901, a data transformer 1920, a stream conditioner 1730, an dyadic distribution algorithm subsystem module 1940 which integrates with a transformation matrix generator 1945, one or more Huffman encoder/decoders 1950, an interleaver 1960 which interfaces with a security subsystem module 1970 and which outputs a compressed and encrypted data stream 1905. In this exemplary architecture, data flows as illustrated. Stream analyzer 1910 first processes the input data 1901, passing its analysis to data transformer 1920. The stream conditioner 1930 then further processes the data before it's passed to dyadic distribution module 1940. The dyadic distribution module/subsystem 1940 works in conjunction with transformation matrix generator 1945 to apply the necessary transformations and generate a secondary transformation data stream. The Huffman encoder/decoder 1950 compresses the data into a compressed input data stream, which is then interleaved with the secondary transformation data stream by interleaver 1960. The security module 1970 interacts with interleaver 1960 to ensure the cryptographic properties of the output stream are maintained. This architecture allows for a modular implementation where each component can be optimized or replaced independently, while still maintaining the overall flow and functionality of the system.

In some implementations, platform 1900 may be implemented as a cloud-based service or system which hosts and/or supports various microservices or subsystems (e.g., components 1910-1970 implemented as microservices/subsystems). In some implementations, platform 1900 may be implemented as computing device comprising a memory and a processor, with computer readable programming instructions (or other computer-readable storage media) stored within the memory and operable/executable by/on the processor which cause the computing device to perform various operations associated with the execution of one or more platform tasks described herein.

According to the embodiment, stream analyzer 1910 is present and configured to analyze an input data stream to determine it statistical properties. This may comprise performing frequency analysis on data blocks within the input stream. It can determine the most frequent bytes or strings of bytes that occur at the beginning of each data block and designates these as prefixes. It may compile a prefix table based on the frequency distribution.

According to the embodiment, data transformer 1920 is present and configured to apply one or more transformations to the data to make it more compressible and secure. In an implementation, the platform applies the Burrows-Wheeler Transform (BWT) to the prefixes in the prefix table. This transformation makes the data more compressible while also providing a layer of encryption.

According to the embodiment, stream conditioner 1930 is present and configured to produce a conditioned data stream and an error stream. For example, for each data block, it compares the block's real frequency against an ideal frequency. If the difference exceeds a threshold, it applies a conditioning rule. It then applies a logical XOR operation and append the output to an error stream.

The dyadic distribution module 1940 receives the data stream and implements the core algorithm. This may comprise transforming the input data into a dyadic distribution whose Huffman encoding is close to uniform. It stores the transformations in a compressed secondary stream which may be (selectively) interwoven with the first, currently processing input stream.

Dyadic distribution module 1940 may integrate with transformation matrix generator 1945. The transformation matrix generator creates and manages the transformation matrix B. According to an aspect, the generator constructs a nonnegative, row-stochastic matrix where each entry represents the probability of transforming one state to another as an instance of matrix B. The matrix is configured to ensure that the transformation reshapes the data distribution while introducing controlled randomness.

According to an implementation, transformation matrix generator 1945 creates the transformation matrix B based on the initial analysis of the input data distribution provided by the stream analyzer. This matrix B is a component that dyadic distribution module 1940 will use throughout the process. As the dyadic distribution module receives each data block, it consults the transformation matrix B to determine how to transform the data. For each state (or symbol) in the input data, the data transformer uses the corresponding row in matrix B to determine the probability distribution for transforming that state to other states. The dyadic distribution module may use a random number generator (such as provided by security module 1970) to select a transformation based on the probabilities in matrix B. This introduces controlled randomness into the process.

Through these transformations, the dyadic distribution module reshapes the data distribution to approach the dyadic distribution implied by the Huffman coding (as determined by the Huffman encoder/decoder). As transformations are applied, dyadic distribution module 1940 provides feedback to transformation matrix generator 1945 about the actual transformations performed. This allows the transformation matrix generator to refine matrix B if necessary. According to an embodiment, if the input data distribution changes over time, the transformation matrix generator can adapt matrix B based on new information from the stream analyzer. The dyadic distribution module will then use this updated matrix for subsequent transformations. The dyadic distribution module keeps track of the transformations it applies and generates a secondary data stream containing this information. This “transformation data” is important for the decoding process and may be interleaved with the main data stream by interleaver 1960. The transformation matrix generator continually works to optimize matrix B to minimize the amount of transformation data needed while maintaining the desired dyadic distribution.

Both transformation components (dyadic distribution module and matrix generator) work together to ensure that the transformations contribute to the cryptographic security of the system.

The transformation matrix generator designs matrix B to make prediction of future states difficult, while the dyadic distribution module applies these transformations in a way that passes the modified next-bit test. In essence, the dyadic distribution module and transformation matrix generator form a tight feedback loop. The transformation matrix generator provides the rules for transformation (in the form of matrix B), while the dyadic distribution module applies these rules to the actual data. The results of these transformations then inform potential updates to the transformation rules, allowing the system to maintain optimal compression and security as it processes the data stream. This close interaction allows the system to dynamically balance compression efficiency and cryptographic security, adapting to changes in the input data characteristics while maintaining the core properties that make the dyadic distribution algorithm effective.

The input data then flows into a Huffman encoder/decoder 5550 which is configured to perform Huffman coding for compression and decoding for decompression. This may comprise constructing a Huffman tree based on the probability distribution of the input data, and assigning shorter codewords to more frequent symbols for compression. For decompression, it reverses the process.

According to the embodiment, interleaver 1960 is present and configured to interleave the compressed and encrypted data streams. This may comprise combining the main data stream (e.g., the input data stream that has been processed by one or more platform components) with the secondary “transformation data” stream according to a specific partitioning scheme to create the final output. This scheme is designed to maximize security while maintaining efficient compression. Interleaver 1960 may integrate with security module 1970 during data processing. In an embodiment, security module implements security features such as the modified next-bit test. For example, the interleaver works with the security module to determine how many bits from each stream should be included in each block of the output. This allocation may be dynamic and based on security requirements and the current state of the data. In some implementations, before interleaving, the security module encrypts the transformation data using a cryptographic algorithm. This adds an extra layer of security to the sensitive information about how the data was transformed. In some implementations, the security module provides cryptographically secure random numbers to the interleaver (or other platform components such as dyadic distribution module). These may be used to introduce controlled randomness into the interleaving process, making it harder for an adversary to separate the two streams.

As the interleaver combines the streams, the security module performs ongoing checks to ensure the resulting stream maintains the required cryptographic properties, such as passing the modified next-bit test. According to an aspect, security module 5570 monitors the entropy of the interleaved stream. If the entropy drops below a certain threshold, it signals the interleaver to adjust its strategy, possibly by including more bits from the transformation data stream. In embodiments where the system uses cryptographic keys (e.g., for encrypting the transformation data), the security module manages these keys and provides them to the interleaver as needed. According to an aspect, based on feedback from the security module about the cryptographic strength of recent output, interleaver 1960 may adaptively change its interleaving strategy.

In an implementation, the security module advises the interleaver on how to maintain consistent timing in its operations to prevent timing-based attacks. This might involve adding deliberate delays or dummy operations. The interleaver may consult the security module on how to securely include any necessary headers or metadata in the output stream. This ensures that even auxiliary data doesn't compromise the system's security. According to an aspect, security module 1970 provides integrity check values (e.g., hash values or MAC codes) to interleaver 1960, which are then incorporated into the output stream. These allow the receiver to verify the integrity of the received data. According to another aspect, security module 1970 guides the interleaver in implementing techniques to resist side-channel attacks, such as ensuring that the power consumption or electromagnetic emissions during interleaving don't leak information about the data being processed.

In an implementation, if the interleaver encounters any issues during the interleaving process, it may consult the security module on how to handle these errors securely without leaking information about the underlying data or transformation process. In an implementation, the interleaver, guided by the security module, can include secure hints or markers in the output stream that will assist in the decoding process without compromising security. The interleaver and security module work in tandem to produce an output stream that is both compressed and securely encrypted. The interleaver focuses on efficiently combining the data streams, while the security module ensures that every step of this process maintains the cryptographic properties of the system. This close cooperation allows the platform to achieve its dual goals of data compression and encryption in a single, efficient process.

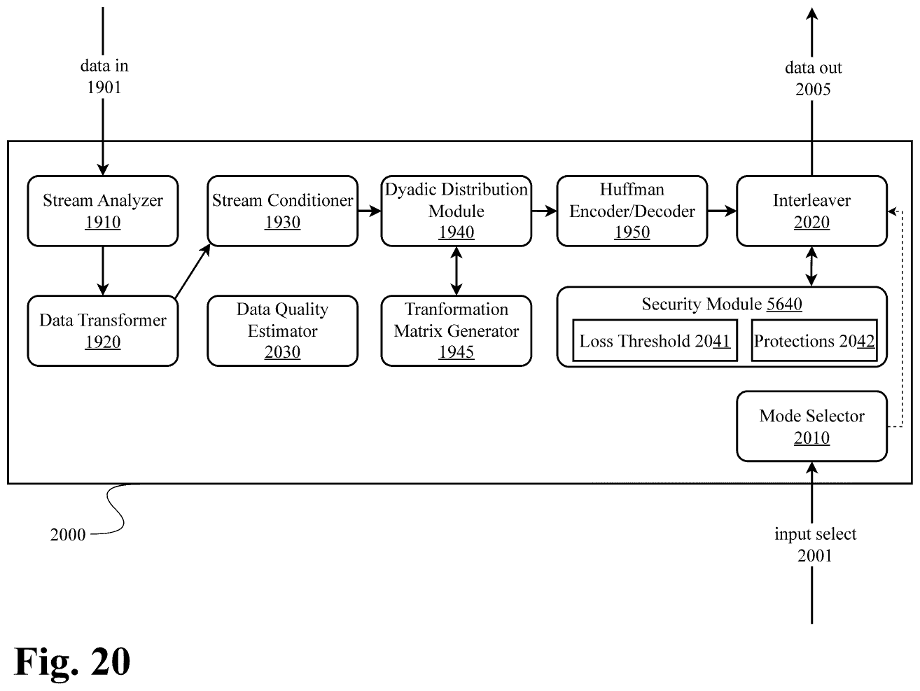

FIG. 20 is a block diagram illustrating another exemplary system architecture for a dyadic distribution-based compression and encryption platform 2000, according to an embodiment. According to an embodiment, a modification to the compression and encryption platform 2000 could be implemented as an optional mode within the existing platform architecture, allowing for flexibility in its application. For example, this may require the addition of a mode selector component 2010, which can determine whether to operate in the original lossless mode, the new lossy, high-security mode, in a modified lossless mode. Mode selector 2010 may receive input data 2001 which selects or otherwise sets the mode of operation of platform 2000. Input select data may be received from various sources such as, for example, a platform user (human or computer implemented agent), or an external application, service, or computing resource.

According to an embodiment, the platform may be modified to only send the modified stream without the secondary stream containing the modification information. This alteration fundamentally changes the nature of the compression from lossless to lossy, while simultaneously strengthening the encryption aspect of the system. The dyadic distribution module, guided by transformation matrix generator 1940, would still modify the input data to achieve a dyadic distribution. However, without the accompanying transformation data stream, perfect reconstruction of the original data becomes impossible, even with possession of the codebook used by Huffman encoder/decoder 1950.

Interleaver 2020 may receive from mode selector 2010 a signal and/or instruction (illustrated as the dotted line) on what process to apply to the one or more input data streams. If the platform is configured to perform the original lossless mode, interleaver 2020 interleaves the compressed input data stream and the secondary transformation data stream. If the platform is configured to perform lossy compression, interleaver 2020 does not interleave the two data streams, but instead transmits only the compressed input data stream. If the platform is configured to perform a modified lossless compression, interleaver 2020 can transmit the compressed input data stream by itself in a first transmission session, and then it may transmit the secondary transformation data stream by itself in a second transmission session. In some embodiments, the secondary transformation data stream may be encrypted according to a suitable data encryption technique prior to transmission. Encryption techniques that may be implemented can include, but are not limited to, advance encryption standard (AES), asymmetric encryption (e.g., RSA), symmetric encryption (e.g., Twofish), and/or the like.

Security module's 2040 role becomes even more critical in the implementation of lossy modified system. It ensures that the encrypted data stream maintains its cryptographic strength, potentially approaching perfect encryption. The absence of the secondary stream eliminates a potential attack vector, as the transformation information is never transmitted. Interleaver's 2020 function would be simplified, focusing solely on managing the primary data stream, but it would still work closely with the security module to maintain the stream's cryptographic properties.

This approach presents a compelling trade-off between data integrity and transmission efficiency coupled with enhanced security. The stream analyzer's role remains the same in analyzing the input data characteristics, allowing the platform to optimize the compression and transformation processes. The loss of data introduced by this method is directly related to the transformations applied by the data transformer, guided by the transformation matrix generator.

Potential applications for this modified system include scenarios where perfect data reconstruction is not critical, but high compression ratios and stringent security requirements are paramount. Examples may include certain types of media streaming, sensor data transmission in IoT environments, or secure transmission of non-critical telemetry data.

According to an embodiment, to address concerns about data integrity, platform 2000 may incorporate a configurable loss threshold 2041 managed by security module 2040. This threshold can allow users to set a maximum acceptable level of data loss. If the estimated loss exceeds this threshold, the platform could automatically revert to the lossless mode or alert the user.

Additionally, the platform may be extended to include a data quality estimator component 5630. This component may work in conjunction with various components (e.g., stream analyzer, data transformer, dyadic distribution module) to provide real-time estimates of the quality of the compressed and encrypted data compared to the original. This could be particularly useful in applications like media streaming, where maintaining a certain level of perceptual quality is crucial.

Finally, it's worth noting that the lossy, high-security mode could potentially offer resistance to certain types of side-channel attacks, as the lack of perfect reconstruction could mask some of the subtle correlations that these attacks often exploit. In an embodiment, security module 2040 can be expanded to include specific protections 2042 against such attacks, further enhancing the overall security profile of the system. These protections would aim to mitigate various types of side-channel vulnerabilities that could potentially leak information about the encryption process or the data being processed. For example, some specific protections that may be implemented can include, but are not limited to, timing attack mitigation, power analysis countermeasures, electromagnetic emission protection, cache attack prevention, branch prediction attack mitigation, fault injection resistance, memory access patter obfuscation, randomization techniques, microarchitectural attack mitigations, side-channel resistant algorithms, runtime monitoring, and adaptive countermeasures.

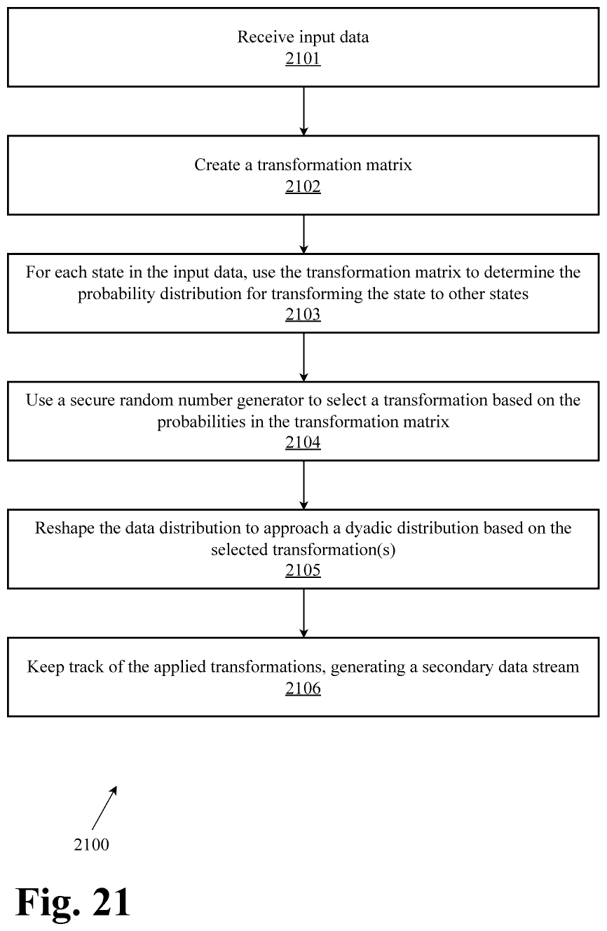

FIG. 21 is a flow diagram illustrating an exemplary method 2100 for implementing a dyadic distribution algorithm, according to an aspect. The method may be performed, in whole or in part, by one or more dyadic distribution-based compression and encryption platforms. According to the aspect, the process begins at step 2101 when dyadic distribution module 1940 receives input data. The input data may have been previously analyzed and processed by other platform components (e.g., stream analyzer, data transformer). At step 2102, the platform creates a transformation matrix using a transformation matrix generator 1945. The transformation matrix may be referred to herein as matrix B. At step 2103, for each state in the input data, module 1940 consults matrix B to determine the probability distribution for transforming that state to other states. According to the aspect, at step 2104 the platform uses a secure random number generator to select a transformation based on the probabilities in the transformation matrix. At step 2105, the platform reshapes the data distribution to approach the dyadic distribution of Huffman encoding based on the selected transformations. At step 2106, the platform keeps track of the applied transformations and generates a secondary data stream.

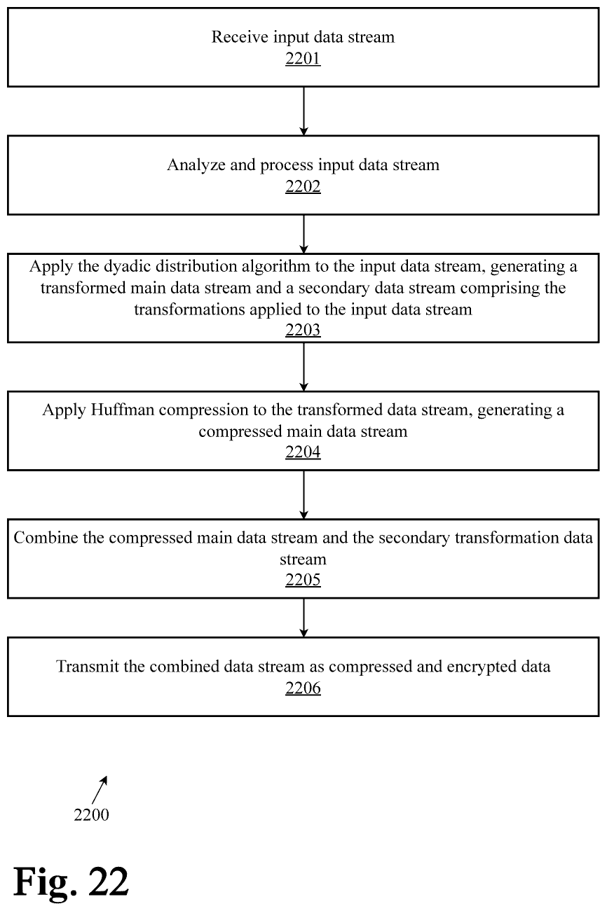

FIG. 22 is a flow diagram illustrating an exemplary method 2200 for providing lossless, dyadic distribution-based compression and encryption, according to an aspect. According to the aspect, the process begins at step 2201 when platform 1900, 2000, receives, retrieves, or otherwise obtains an input data stream. At step 2202, the platform analyzes and processes the input data stream. This may comprise frequency analysis as performed by a stream analyzer subsystem and processing performed by a data transformer and/or a stream conditioner. At step 2203, the platform applies the dyadic distribution algorithm to the input data stream (which may have been processed at step 2202), generating a transformed main data stream and a secondary data stream comprising the transformations applied to the input data stream. The secondary data stream may be sent to an interleaver subsystem for transmission. At step 2204, the platform applies Huffman compression to the transformed main data stream, generating a compressed main data stream. The interleaver can obtain both data streams and combine them into an interleaved data stream at step 2205. At step 2206, the platform transmits the combined data stream as a compressed and encrypted data stream. The transmitted data may be received on the receiving end with a platform configured with an Huffman decoder which can decompress the received main data stream using the attached secondary stream and the proper codebook.

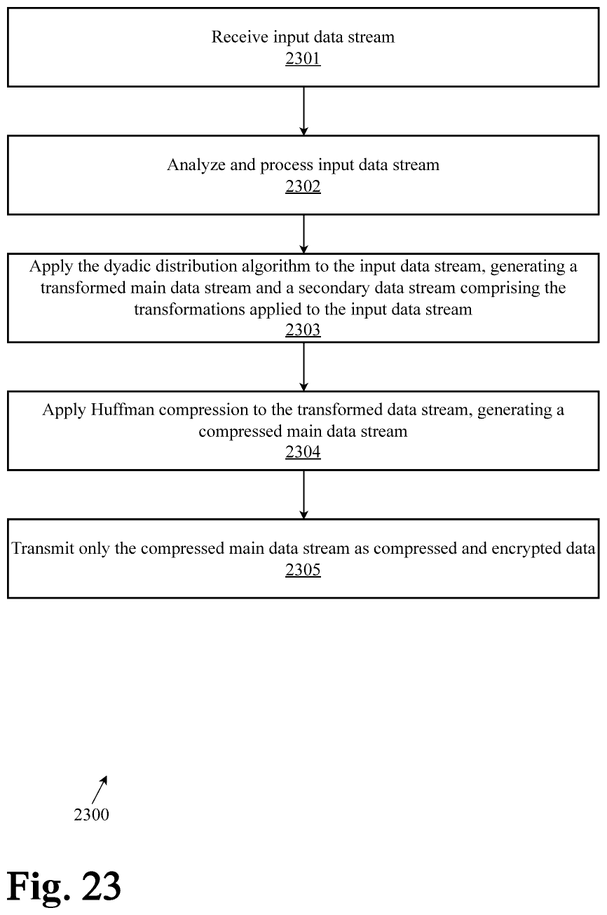

FIG. 23 is a flow diagram illustrating an exemplary method 2300 for providing lossy, dyadic distribution-based compression and encryption, according to an aspect. According to the aspect, the process begins at step 2301 when platform 1900, 2000, receives, retrieves, or otherwise obtains an input data stream. At step 2302, the platform analyzes and processes the input data stream. This may comprise frequency analysis as performed by a stream analyzer subsystem and processing performed by a data transformer and/or a stream conditioner. At step 2303, the platform applies the dyadic distribution algorithm to the input data stream (which may have been processed at step 2302), generating a transformed main data stream and a secondary data stream comprising the transformations applied to the input data stream. At step 2304, the platform applies Huffman compression to the transformed main data stream, generating a compressed main data stream. In this embodiment, the platform may have obtained a mode of operation command which indicates the platform is to perform lossy compression. In such an embodiment, the interleaver does not obtain both data streams and combine them into an interleaved data stream at step. At step 2305, the platform transmits only the compressed main data stream as a compressed and encrypted data stream. The transmitted data may be received on the receiving end with a platform configured with an Huffman decoder which can decompress the received main data stream, however because there is no accompanying secondary data stream, the decompressed main data stream would be considered lossy because it cannot be reconstructed due to the dyadic transformations applied at step 2303.

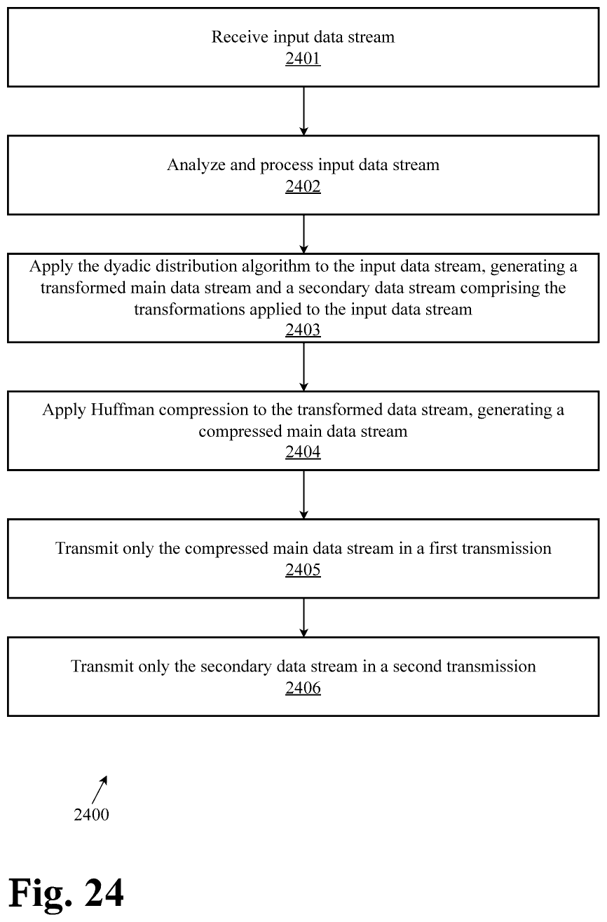

FIG. 24 is a flow diagram illustrating an exemplary method 2400 for providing modified lossless, dyadic distribution-based compression and encryption, according to an aspect. According to the aspect, the process begins at step 2401 when platform 1900, 2000, receives, retrieves, or otherwise obtains an input data stream. At step 2402, the platform analyzes and processes the input data stream. This may comprise frequency analysis as performed by a stream analyzer subsystem and processing performed by a data transformer and/or a stream conditioner. At step 2403, the platform applies the dyadic distribution algorithm to the input data stream (which may have been processed at step 2402), generating a transformed main data stream and a secondary data stream comprising the transformations applied to the input data stream. The secondary data stream may be sent to an interleaver subsystem for transmission. At step 2404, the platform applies Huffman compression to the transformed main data stream, generating a compressed main data stream. In this embodiment, the platform may have obtained a mode of operation command which indicates the platform is to perform modified lossless compression. In such an embodiment, the interleaver does not combine both data streams into an interleaved data stream at step. At step 2405, the platform transmits only the compressed main data stream as a compressed and encrypted data stream. At step 2406, the platform transmits only the secondary data stream in a second transmission. The transmitted data may be received on the receiving end with a platform configured with an Huffman decoder which can decompress the received main data stream using the secondary data stream and the codebook.

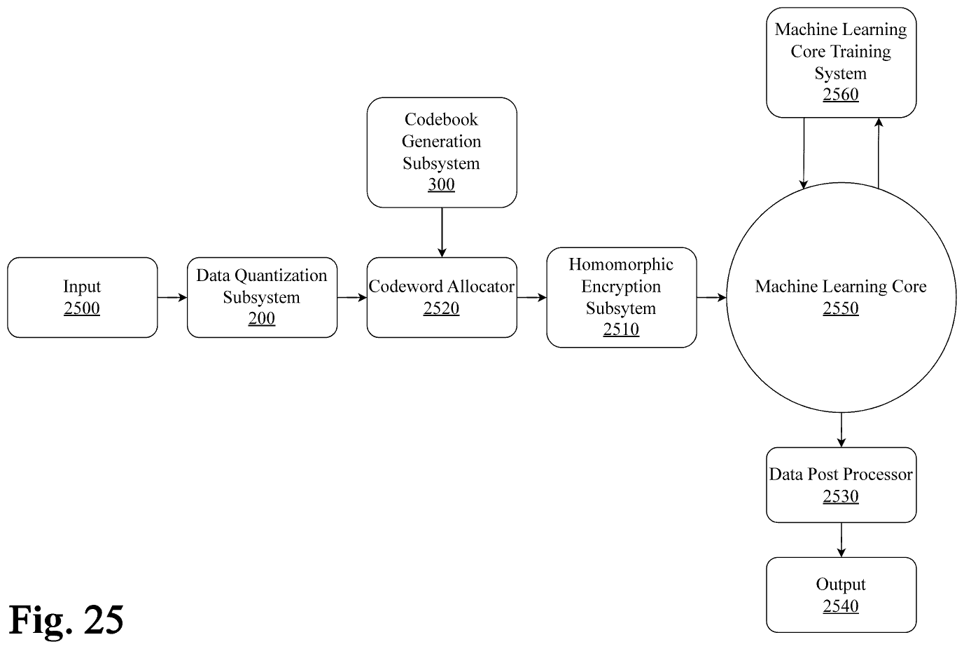

FIG. 25 is a block diagram illustrating an exemplary system architecture for processing homomorphic compressed and encrypted data through a deep learning platform. The system comprises several interconnected components that work together to process input data, compress it, encrypt it, and then analyze it using a machine learning model trained on similarly processed data. The system operates on a plurality of input data 2500, which could represent a variety of data types such as but not limited to Internet-of-Things (IoT) sensor data, financial data, or medical data. This input data is first passed through a data quantization subsystem 200.

Data quantization subsystem 200 is responsible for dividing the range of input data 2500 into a finite set of intervals, each represented by a unique codeword. This process discretizes the continuous or high-precision input data into a smaller set of discrete values, reducing the complexity and size of the data representation. For example, if the input data consists of temperature readings ranging from −10° C. to 50° C., data quantization subsystem 200 might divide this range into 20 intervals, each of size 3° C. A temperature reading of 25.6° C. would then be quantized to the interval [25, 28) and assigned a specific code.

The quantized data is then passed to a codebook generation subsystem 300. This subsystem is responsible for creating a compact and efficient representation of the quantized data. It assigns unique codewords to each interval of the quantized data based on a selected codebook generation technique. For instance, using Huffman coding, the system might assign shorter codewords to more frequently occurring intervals and longer codewords to less frequent intervals. This results in a codebook that maps each quantized interval to a specific codeword, enabling efficient compression of the data.

A codeword allocator 2520 works in conjunction with codebook generation subsystem 300. It takes the quantized data and the generated codebook, and replaces each quantized value with its corresponding codeword. This step effectively compresses the data, as the codewords are typically much shorter than the original data values. For example, if our temperature data has been quantized into 20 intervals, each interval could be represented by a codeword of just 5 bits, significantly reducing the data size.

The compressed data then moves to a homomorphic encryption subsystem 2510.

Homomorphic encryption subsystem 2510 encrypts the compressed codewords using a homomorphic encryption scheme, such as the Paillier cryptosystem. The key feature of homomorphic encryption is that it allows computations to be performed on the encrypted data without needing to decrypt it first.

Homomorphic encryption subsystem 2510 receives codewords from the codeword allocator 2520 and applies a homomorphic encryption scheme to each codeword. This process allows computations to be performed on the encrypted data without the need for decryption, thereby maintaining data privacy and security throughout the analysis process. When encrypting the codewords, each is treated as a numerical value or a vector of numerical values. The homomorphic encryption algorithm is then applied to these values, resulting in encrypted data that maintains the algebraic relationships of the original codewords. This property is essential for enabling meaningful computations on the encrypted data in subsequent stages of processing.

Several homomorphic encryption methods could be employed within this subsystem, each with its own strengths and characteristics. The Paillier cryptosystem, for instance, is a partially homomorphic encryption scheme that supports addition operations on encrypted data. In practice, this means that if two codewords are encrypted representing quantized temperature values, such as 3 and 5, encrypted values may be obtained such as 24601 and 62092. These encrypted values can then be multiplied together (modulo a public key) to obtain the encryption of the sum of the original values, allowing a machine learning core to perform addition operations without knowing the actual values.

Another potential method is the Brakerski-Gentry-Vaikuntanathan (BGV) scheme, a fully homomorphic encryption scheme supporting both addition and multiplication on encrypted data. With BGV, codewords might be encrypted as vectors, allowing for component-wise operations that enable more complex computations in the machine learning core. The Cheon-Kim-Kim-Song (CKKS) scheme is particularly well-suited for machine learning applications, as it allows for approximate computations on encrypted real or complex numbers. This scheme could be especially useful if codewords represent floating-point values, as it would allow a machine learning core to perform both addition and multiplication on these encrypted values, with the results approximating operations on the original values.

The encryption process ensures that the output from this subsystem is suitable as input for a machine learning core 2550 in several ways. It preserves the structure of the data, maintaining algebraic relationships between codewords and allowing the machine learning model to detect patterns in the encrypted data. The process also transforms all encrypted codewords into a consistent format, typically vectors of fixed length, which can be easily processed by neural networks. Many homomorphic encryption schemes, especially those designed for machine learning like CKKS, include mechanisms to manage the scale of encrypted values, preventing the accumulation of error during computations. This allows for maintaining accuracy in the machine learning model.

Advanced homomorphic encryption schemes often support batch processing, allowing multiple codewords to be encrypted together. For example, using the CKKS scheme, a batch of codewords could be encrypted as a single ciphertext. This capability allows the machine learning core to perform operations on multiple data points simultaneously, significantly enhancing computational efficiency. Homomorphic encryption subsystem 2510 may also include components for selecting optimal encryption parameters based on the requirements of the machine learning core and the nature of the input data, managing the noise introduced by homomorphic encryption schemes, and securely managing encryption keys.

By carefully encrypting the codewords using these homomorphic techniques, homomorphic encryption subsystem 2510 transforms the compressed data into a form that can be securely and effectively processed by the machine learning core. This approach enables powerful data analysis and machine learning operations to be performed while maintaining the highest levels of data privacy and security, opening up new possibilities in fields where data sensitivity is a critical concern, such as healthcare, finance, and smart city management.

The encrypted, compressed data is then fed into the machine learning core 2550. Machine learning core 2550 is a deep learning model that has been specifically trained to operate on homomorphically compressed and encrypted data. The model may be any kind of architecture, depending on the needs of the user. Examples of possible architectures include but are not limited to, traditional transformers, latent transformers, convolutional neural networks, recurrent neural networks, variational autoencoders, and diffusion models.

Machine learning core 2550 might be trained to predict energy consumption patterns based on encrypted IoT sensor data from smart homes. It could analyze patterns in the encrypted temperature data, along with other encrypted sensor readings, to make accurate predictions without ever accessing the raw, unencrypted data. This maintains the privacy of individual households while still allowing for valuable insights to be drawn from the aggregate data.

A machine learning core training system 2560 is responsible for training machine learning core 2550. This system uses large datasets of compressed and encrypted data to train the deep learning model, optimizing its ability to recognize patterns and make predictions based on the encrypted codewords. The training process might involve techniques like federated learning, where the model is trained across multiple decentralized edge devices holding local data samples, without exchanging them.

The output from the machine learning core 2550 is processed by a data post processor 2530. This component interprets the results from machine learning core 2550, which are still in an encrypted form, and prepares them for final output. The post-processing might involve tasks such as decrypting the results (if authorized), aggregating predictions, or formatting the output for specific applications or user interfaces.

Machine learning core 2550, specially designed to operate on homomorphically encrypted and compressed data, is capable of making sophisticated predictions and inferences without ever decrypting the underlying information. In the context of a credit score example, this core might analyze patterns in encrypted payment histories, credit utilization rates, and other financial behaviors to predict future credit score trends or identify potential credit risks. The core 2550 could, for instance, infer that a certain pattern of encrypted credit utilization is indicative of a high likelihood of score improvement in the next six months, or that a particular combination of encrypted payment behaviors signals an increased risk of default.

These predictions and inferences are generated through a series of complex mathematical operations performed entirely in the encrypted domain. The machine learning core 2550 might employ techniques such as encrypted neural network forward passes, homomorphic convolutions, or secure multi-party computation protocols to process the data. For example, it could use encrypted gradient boosting techniques to identify the most important factors contributing to credit score changes, or apply homomorphic versions of clustering algorithms to segment customers into risk categories based on their encrypted financial profiles. In another example, information may be processed through a latent transformer to achieve inferences or predictions. The results of these operations, be they risk scores, trend predictions, or customer segments, are produced in an encrypted and compressed format, maintaining the security and privacy of the original data. This allows for highly nuanced and accurate predictions to be made and shared across different entities or departments within a financial institution, or even between different institutions, without ever exposing the sensitive individual-level data that forms the basis of these insights.

The final output 2540 represents the results of the entire process. This could take many forms depending on the specific application. In the energy consumption prediction example, the output might be encrypted predictions of energy usage for the next 24 hours, which could be used by energy providers to optimize grid operations without compromising individual consumer privacy.

This system architecture represents a powerful fusion of data compression, homomorphic encryption, and deep learning technologies. It enables highly secure and privacy-preserving data analysis, opening up new possibilities in fields where data sensitivity is a critical concern, such as healthcare, finance, and smart city management. The ability to perform complex machine learning operations on encrypted data, without ever exposing the underlying information, represents a significant advancement in privacy-preserving computation and data analysis.

In one embodiment, the output from the machine learning core, still in its encrypted and compressed form, can be seamlessly integrated back into the source system to update and refine its data or operations. This circular flow of information allows for continuous improvement and adaptation of the system without compromising data security. For instance, in a credit score example, the encrypted predictions or risk assessments generated by the machine learning core could be fed back into the credit reporting system to update individual credit profiles or adjust risk models.

This feedback loop operates entirely in the encrypted domain, leveraging the homomorphic properties of the encryption scheme. The encrypted outputs can be used to perform mathematical operations on the existing encrypted data in the source system, effectively updating it without decryption. For example, an encrypted prediction of a likely credit score change could be homomorphically added to the current encrypted credit score, adjusting it based on the machine learning model's insights. Similarly, encrypted risk assessments could be used to update the weighting of various factors in the credit scoring algorithm, all while the data remains secure and compressed. This approach allows for dynamic, data-driven refinement of the system's operations, enhancing its accuracy and responsiveness to emerging trends, while maintaining the highest levels of data privacy and security. The ability to update and modify the source system using encrypted, compressed outputs ensures that sensitive information remains protected throughout the entire data lifecycle, from initial collection through analysis and back to operational use.

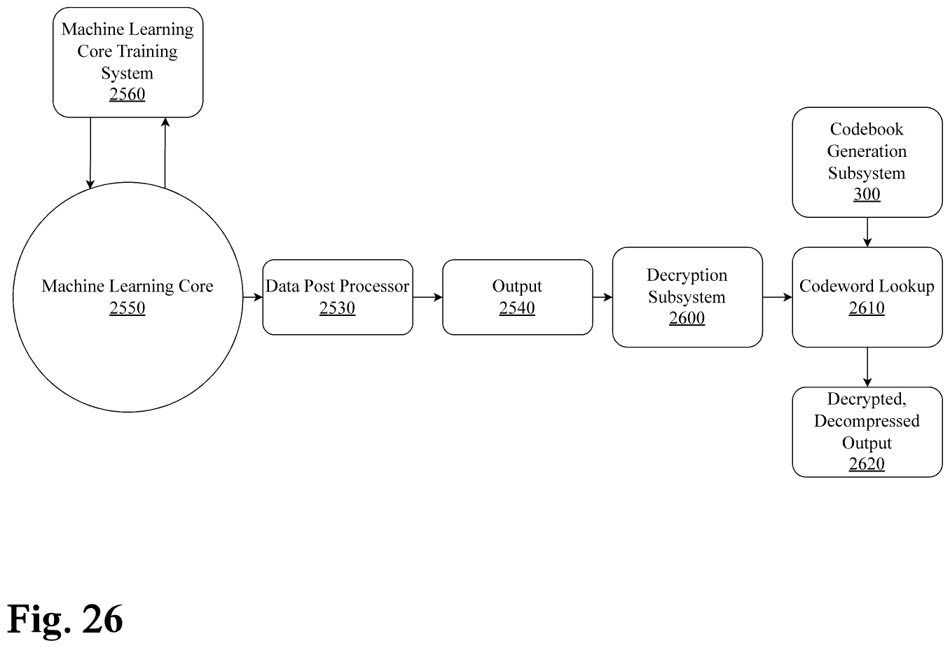

FIG. 26 is a block diagram illustrating an exemplary system architecture for decompressing and decrypting homomorphic compressed and encrypted data after being processed by deep learning platform. The system starts with the output from machine learning core 2550, which remains in an encrypted and compressed state. This output, still in the form of encrypted codewords, represents the results of complex analyses performed on the data while it was in its secure, encrypted form. For example, in a healthcare application, this might represent predictions about patient outcomes or detected patterns in medical imaging data, all computed without ever exposing the raw, sensitive patient data.

The encrypted output first passes through a data post processor 2530. This component plays a role in preparing the encrypted results for decryption and decompression. It may perform tasks such as reformatting the data, aggregating results from multiple analyses, or applying any final transformations needed before the decryption process begins. In our healthcare example, this might involve combining predictions from multiple machine learning models or preparing the encrypted results for integration with existing medical record systems.

The processed encrypted data enters a decryption subsystem 2600. Decryption subsystem 2600 is the counterpart to the homomorphic encryption subsystem 2510. Its primary function is to reverse the homomorphic encryption, converting the secure, encrypted representations back into their compressed codeword form. Decryption subsystem 2600 employs the same homomorphic encryption schemes used in the encryption process, but in reverse. For instance, if the Paillier cryptosystem was used, the decryption process would involve modular exponentiation operations to recover the original numerical values. In the case of more advanced schemes like BGV or CKKS, the decryption process would involve more complex mathematical operations to recover the approximate values of the original data from their encrypted vector representations.

Once decrypted, the data is still in its compressed form, represented by codewords. This is where the codeword lookup 2610 comes into play. This component works in tandem with codebook generation subsystem 300, which maintains the mapping between codewords and their corresponding data values. The codeword lookup process involves replacing each codeword with its original data value or range, effectively decompressing the data. For example, if the system was working with temperature data, a codeword ‘01101’ might be looked up and replaced with the temperature range it represents, say 22° C. to 24° C. This process is applied to all the codewords in the decrypted output, gradually reconstructing the original data structure.

Codebook generation subsystem 300, which was instrumental in the initial compression of the data, now serves a role in this decompression process. It provides codeword lookup 2610 with the necessary mapping information to accurately interpret the codewords. This subsystem ensures that the decompression is performed consistently with the original compression, maintaining the integrity of the data throughout its journey through the system.

After the codeword lookup process the system outputs a decrypted, decompressed output.

This represents the final, human-readable form of the data, transformed from its secure, compressed, and encrypted state back into its original format. In a healthcare example, this might be clear text predictions about patient outcomes, readable medical image analyses, or other clinically relevant information. This decryption and decompression process completes the cycle of secure data processing. It allows the system to provide meaningful, actionable outputs while maintaining the highest levels of data security and privacy throughout the entire analysis pipeline. This approach opens up powerful possibilities in fields dealing with sensitive data, enabling advanced machine learning analyses without compromising data confidentiality.

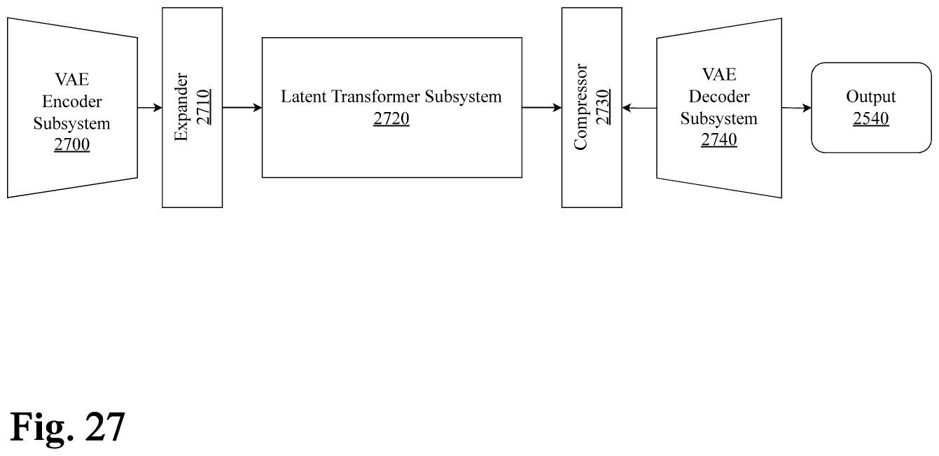

FIG. 27 is a block diagram illustrating an exemplary system architecture for a latent transformer core, which is a possible machine learning core for processing homomorphic compressed and encrypted data through a deep learning platform. At the heart of the system is a Latent Transformer Subsystem 2770, which serves as the central processing unit responsible for learning the underlying patterns, relationships, and dependencies within the input data. The Latent Transformer Subsystem 2770 leverages advanced techniques such as self-attention mechanisms and multi-head attention to capture the complex interactions and sequences in the data, enabling it to generate accurate and context-aware outputs.

The input to the Latent Transformer Subsystem 2770 is provided by a VAE Encoder Subsystem 2750. The VAE Encoder Subsystem 2750 is responsible for encoding the preprocessed input data into a lower-dimensional latent space representation. An input is passed through the VAE Encoder Subsystem 2750, which learns to compress the data into a compact latent space representation while preserving the essential features and characteristics of the input.

Latent space vectors produced by the VAE Encoder Subsystem 2750 may be further processed by an expander 151, which increases the dimensionality of the input data to a point where the vectors can be efficiently processed by the Latent Transformer Subsystem 2770.

The latent space representation generated by the VAE Encoder Subsystem 2750 serves as the input to the Latent Transformer Subsystem 2770. The Latent Transformer Subsystem 2770 operates in this latent space, leveraging the compressed and informative representation to learn the complex patterns and relationships within the data. By working in the latent space, the Latent Transformer Subsystem 2770 can efficiently process and model the data, capturing the intricate dependencies and generating accurate and meaningful outputs.

Once the Latent Transformer Subsystem 170 has processed the latent space representation, the generated output is passed through the VAE Decoder Subsystem 2780. The VAE Decoder Subsystem 2780 is responsible for decoding the latent space representation back into the original data space. Prior to processing by the VAE Decoder Subsystem 2780, Latent Transformer Subsystem outputs may be compressed back to an original size before being processed by the expander 2751 by being processed by a compressor 2752. The VAE Decoder Subsystem 2780 learns to reconstruct the original data from the latent space representation, ensuring that the generated output is coherent and meaningful.

The reconstructed output from the VAE Decoder Subsystem 2780 is provided as the generated output 2790. The generated output 2790 represents the final result of the Latent Transformer LCM system, which can take various forms depending on the specific task and domain. It could be predicted values for time series forecasting, generated text for language modeling, synthesized images for computer vision tasks, or any other relevant output format.

The VAE Encoder Subsystem 2750 and VAE Decoder Subsystem 2780 play large roles in the overall functioning of the Latent Transformer LCM system. The VAE Encoder Subsystem 2750 enables the system to learn a compressed and informative representation of the input data in the latent space, while the VAE Decoder Subsystem 2780 ensures that the generated output is coherent and meaningful by reconstructing it back into the original data space. The combination of these subsystems allows the Latent Transformer Subsystem 2770 to focus on learning the complex patterns and relationships within the data, leading to accurate and context-aware outputs.

The specific architectures and parameters of the VAE Encoder Subsystem 2750, Latent Transformer Subsystem 2770, and VAE Decoder Subsystem 2780 can be customized and adapted based on the characteristics and requirements of the input data and the specific task at hand. The modular design of the system allows for flexibility and extensibility, enabling the integration of different architectures, attention mechanisms, and training techniques to optimize the performance and efficiency of the Latent Transformer LCM system.

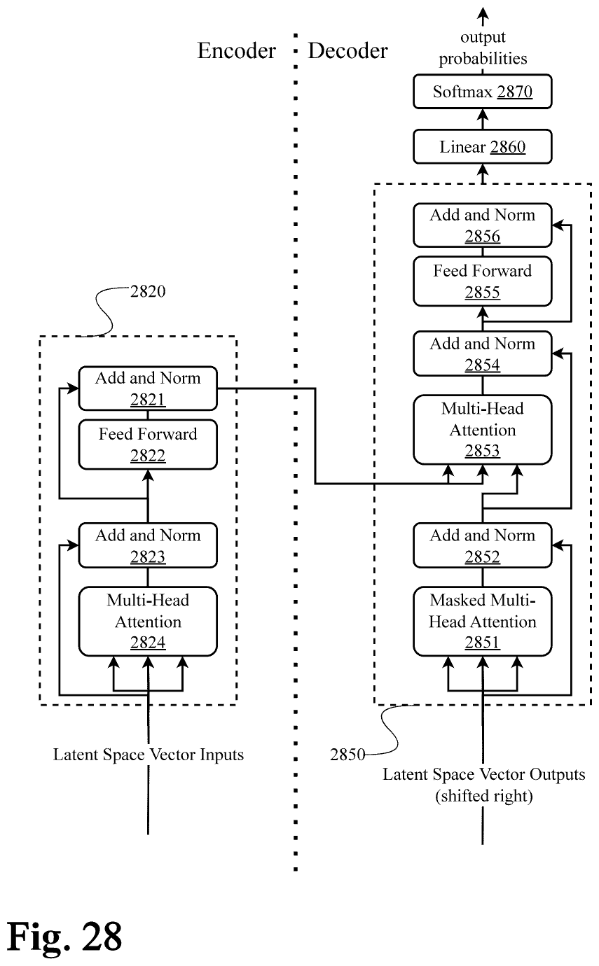

FIG. 28 is a block diagram illustrating a component of the system processing homomorphic compressed and encrypted data through a deep learning platform, a Latent Transformer. A Transformer generally comprises an Encoder (the components on the left side of the illustration) and a Decoder (the components on the right side of the illustration).

The illustrated Latent Transformer comprises an Encoder and a Decoder. The Encoder takes latent space vector inputs and processes them through a stack of layers (represented as dashed box 420). Each layer consists of: multi-head attention, which allows the model to attend to different parts of the input sequence; add and norm, which applies residual connection and layer normalization; feed forward, which is a fully connected feed-forward network; and add and norm which is another residual connection and layer normalization.

The power of the transformer model lies in the self-attention mechanism. This mechanism contributes to accelerated learning compared to traditional models such as long short-term memory models. Self-attention empowers the transformer model with the remarkable capability to meticulously scrutinize distinct segments of a given sequence or even encompass the entire contextual essence of a sentence. This profound contextual awareness enables the model to make predictions with an elevated degree of accuracy and relevance.

Contrary to a standard transformer architecture, in a Latent Transformer, an input embedding layer and a positional encoding layer are not necessary. This is because rather than processing data inputs, a Latent Transformer processes latent space vectors which have been processed by a Variational Autoencoder encoder.

This latent space representation captures the essential features and characteristics of the input data, including both the content and positional information. By encoding the input data into a compact latent vector, the VAE effectively combines the roles of the embedding layer and positional encoding layer. The latent vectors generated by the VAE encoder already contain the necessary information for the Transformer to process and learn from, without the need for explicit embedding or positional encoding. This streamlined approach simplifies the Transformer architecture and reduces the computational overhead associated with maintaining separate embedding and positional encoding layers. As a result, the Latent Transformer LCM system can efficiently process and generate data in the latent space, leveraging the power of the Transformer architecture while benefiting from the compressed representation learned by the VAE.

The Encoder utilizes a multi-head attention mechanism 2824 which allows the Encoder to attend to different parts of the input sequence and capture dependencies between vectors. The attention mechanism computes three matrices: Query (Q), Key (K), and Value (V). The Query, Key, and Value matrices are obtained by linearly projecting the input embeddings using learned weight matrices. The attention scores are computed by taking the dot product of the Query matrix with the transpose of the Key matrix, followed by scaling and applying a softmax function. The attention scores determine the importance of each vector in the input sequence for a given position. The Value matrix is then multiplied with the attention scores to obtain the weighted sum of the values, which forms the output of the attention mechanism. Multi-Head Attention splits the Query, Key, and Value matrices into multiple heads, allowing the model to attend to different aspects of the input simultaneously. The outputs from each head are concatenated and linearly projected to obtain the final output of the Multi-Head Attention layer 2824.

In the Latent Transformer LCM system, the number of attention heads used by the Encoder can be adjusted based on the complexity and nature of the relationships within the input data. The attention mechanism allows the Encoder to focus on different aspects of the input and capture dependencies between elements at various positions. When dealing with datasets where the relationships between elements are weaker or more subtle, increasing the number of attention heads can be beneficial. By having more attention heads, the Encoder can learn and capture a wider range of patterns and dependencies within the data. Each attention head can attend to different parts of the input sequence, allowing the model to capture fine-grained relationships and nuances that may be difficult to detect with fewer attention heads. This is particularly useful when working with complex or heterogeneous datasets, where the relationships between elements may not be immediately apparent. By increasing the number of attention heads, the Latent Transformer LCM system can more effectively learn and represent the underlying structure and dependencies in the data, leading to improved performance and generalization. However, it's important to strike a balance, as having an excessive number of attention heads can increase computational complexity and may lead to overfitting. Experimentation and evaluation on specific tasks can help determine the optimal number of attention heads for a given dataset and desired outcome.

After the Multi-Head Attention layer, a residual connection is applied, followed by Layer Normalization at add and norm 2823. The residual connection adds the input embeddings to the output of the attention layer, helping the model learn faster and deeper. Layer Normalization normalizes the activations across the features, stabilizing the training process.

The Feed Forward layer 2822 is a fully connected neural network applied to each position of the Encoder's hidden states. It consists of two linear transformations with a Rectified Linear Unit (ReLU) activation function in between. The purpose of the Feed Forward layer is to introduce non-linearity and increase the model's capacity to learn complex representations. The output of the Feed Forward layer has the same dimensionality as the input embeddings. A residual connection and Layer Normalization 2821 are applied after the Feed Forward layer.

The Encoder layers 2820 are stacked Nx times, where N is a hyperparameter that determines the depth of the Encoder. Each layer follows the same structure: Multi-Head Attention, Add & Norm, Feed Forward, and Add & Norm. By stacking multiple Encoder layers, the model can capture hierarchical and long-range dependencies in the input sequence. The output of the final Encoder layer represents the encoded input sequence, which is then passed to the Decoder for generating the output sequence.

The Decoder generates the output probabilities. It has a similar structure to the Encoder, with a few additions. The Decoder takes output embeddings and processes them through a stack of layers (represented as dashed box 2850). The latent space vector output layer 2830 takes the previous output vectors (shifted right by one position) and processes them through a plurality of layers.

The masked multi-head attention 2851 mechanism prevents the model form attending to future vectors. This layer performs self-attention on the Decoder's input sequence. It allows the Decoder to attend to different parts of its own input sequence. The attention is “masked” to prevent the Decoder from attending to future vectors, ensuring that the predictions are based only on the previously generated vectors. Multi-head attention splits the input into multiple heads, allowing the model to attend different aspect of the input simultaneously.

After the masked multi-head attention, a residual connection is applied follows by layer normalization via add and norm 2852. The residual connection adds the input to the output of the attention layer, helping the model learn faster and deeper. Layer normalization normalizes the activations across the features, stabilizing the training process.

The multi-head attention 2853 layer performs attention between the Decoder's hidden states and the Encoder's output. It allows the Decoder to attend to relevant parts of the input sequence based on the Encoder's representations. The attention weights are computed based on the compatibility between the Decoder's hidden states and Encoder's outputs.

In the Latent Transformer LCM system, the number of attention heads used by the Decoder can be adjusted based on the complexity and nature of the relationships within the input data. The attention mechanism allows the Decoder to focus on different aspects of the input and capture dependencies between elements at various positions. When dealing with datasets where the relationships between elements are weaker or more subtle, increasing the number of attention heads can be beneficial. By having more attention heads, the Decoder can learn and capture a wider range of patterns and dependencies within the data. Each attention head can attend to different parts of the input sequence, allowing the model to capture fine-grained relationships and nuances that may be difficult to detect with fewer attention heads. This is particularly useful when working with complex or heterogeneous datasets, where the relationships between elements may not be immediately apparent. By increasing the number of attention heads, the Latent Transformer LCM system can more effectively learn and represent the underlying structure and dependencies in the data, leading to improved performance and generalization. However, it's important to strike a balance, as having an excessive number of attention heads can increase computational complexity and may lead to overfitting. Experimentation and evaluation on specific tasks can help determine the optimal number of attention heads for a given dataset and desired outcome.

Another add and norm 2854 layer is then followed by feed forward network 2855. This a fully connected feed-forward network applied to each position of the Decoder's hidden states. It consists of two linear transformations with a Rectified Linear Unit (ReLU) activation in between. The feed forward layer helps the model capture non-linear interactions and increases the model's capacity.

Another add and norm 2856 layer is followed by linear 2860 and softmax 2870 layers. The final hidden states of the Decoder are passed through a linear transformation to project them into the vocabulary space. Vocabulary space refers to the set of all unique codewords or words that the model can generate or predict. In the context of language models, the vocabulary is a predefined set of codewords that the model is trained on and can output. When the Decoder's final hidden states are passed through a linear transformation, they are projected into a vector space with the same dimensionality as the size of the vocabulary. Each dimension in this space corresponds to a specific codeword in the vocabulary.

A softmax function is applied to the projected values (vectors) to generate output probabilities over the vocabulary. The softmax function normalizes the values so that they sum up to 1, representing a probability distribution over the vocabulary. Each probability indicates the likelihood of a specific vector being the next output vector. The vector with the highest probability is selected as the next output vector. During the model's training, the objective is to maximize the probability of the correct next vector given the input sequence and the previously generated vector. The model learns to assign higher probabilities to the vector that are more likely to appear based on the context. At inference time, the vector with the highest probability in the vocabulary space is selected as the next output vector. This process is repeated iteratively, with the generated vector being fed back into the Decoder as input for the next step, until a stopping criterion is met (e.g., reaching a maximum length or generating an end-of-sequence vector). The size and composition of the vocabulary can vary depending on the specific task and the data the model is trained on. It can include words, sub-words, or even characters, depending on the codeword strategy used.

The Decoder layers 2850 can be stacked Nx times, allowing the model to capture complex dependencies and generate coherent output sequences.

This transformer architecture allows the model to process input sequences, capture long-range dependencies, and generate output sequence based on the encoded input and the previously generated codewords.

Another type of variation is the auto-regressive model which feature the use of only the decoder portion of the transformer architecture. In autoregressive architectures, the decoder portion of the transformer is retained and the encoder portion is not used after model pre-training. Auto-regressive models are a class of models that generate outputs by predicting the next element based on the previously generated elements. In the context of the Transformer architecture and language modeling, auto-regressive models are commonly used for tasks such as text generation, machine translation, and language understanding.

Auto-regressive models generate outputs sequentially, one element at a time. In the case of language modeling, the model predicts the next word or vector based on the previous words or vector in the sequence. The prediction of the next element is conditioned on the previously generated elements. The model learns the conditional probability distribution P(x_t|x_l, x_2, . . . , x_{t−1}), where x_t is the element at position t, and x_1, x_2, . . . , x_{t−1} are the previously generated elements. The Transformer architecture, particularly the Decoder component, is well-suited for auto-regressive modeling. The Decoder generates the output sequence one element at a time, conditioned on the previously generated elements and the encoded input sequence from the Encoder. In the Transformer Decoder, the self-attention mechanism is masked to prevent the model from attending to future positions during training. This masking ensures that the model relies only on the previously generated elements to make predictions, following the auto-regressive property. During training, the Transformer Decoder uses a technique called teacher forcing. Instead of feeding the model's own predictions as input for the next step, the ground truth target sequence is used. This helps the model learn to generate the correct output sequence based on the input sequence and the previous target vectors. During inference or generation, the Transformer Decoder generates the output sequence one element at a time. At each step, the model takes the previously generated elements as input and predicts the next element. This process continues until a stopping criterion is met, such as reaching a maximum sequence length or generating an end-of-sequence vector. Auto-regressive models, including the Transformer, have achieved state-of-the-art performance in language modeling tasks. They excel at capturing the statistical properties and dependencies in sequential data, making them effective for generating coherent and fluent text.

While text generation is the most suitable use case of auto-regressors, they perform exceptionally well on a wide variety of tasks. Most modern LLMs are auto-regressors including, for example, the popular GPT series of LLMs, BERT, and XLNet.

The third variation of the transformer model is the sequence-to-sequence model which utilizes both the encoder and decoder portions of the transformer and can be trained in multiple ways. One of the methods is span corruption and reconstruction. These models are, generally, best suited for language translation. The T5 and BART family of models are examples of sequence-to-sequence models.

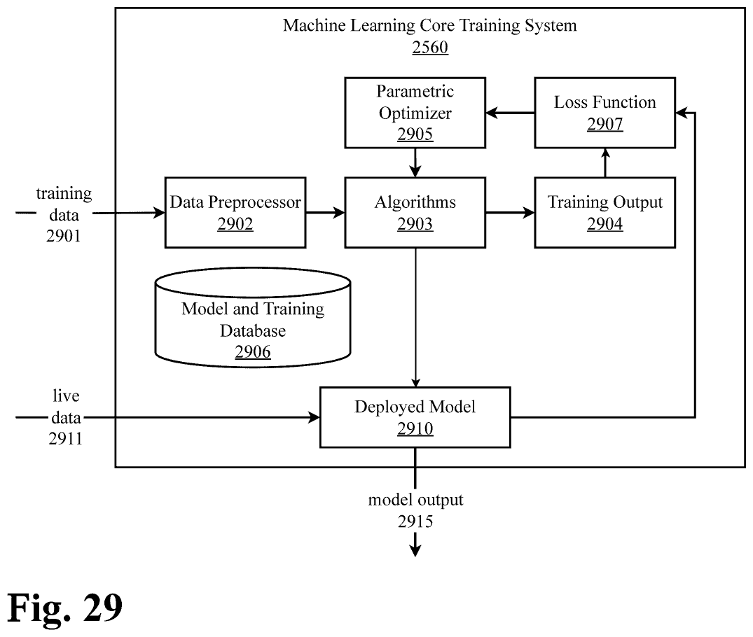

FIG. 29 is a block diagram illustrating a component of the system for processing homomorphic compressed and encrypted data through a deep learning platform, a machine learning core training system. According to the embodiment, the machine learning core training system 2900 may comprise a model training stage comprising a data preprocessor 2902, one or more machine and/or deep learning algorithms 2903, training output 2904, and a parametric optimizer 2905, and a model deployment stage comprising a deployed and fully trained model 2910 configured to perform tasks described herein such as processing codewords through a large codeword model. The machine learning training system 2900 may be used to train and deploy a plurality of machine learning architectures in order to support the services provided by the large codeword model for deep learning. In one embodiment, machine learning training system 2900 may be used to train the VAE Encoder Subsystem 2750, the Latent Transformer Subsystem 2770, and the VAE Decoder Subsystem 2780. The machine learning core training system 2900 may train each of the proceeding systems separately or together as a single system. Additionally, the machine learning core training system 2900 may be configured to train any core type outside of a latent transformer core such as but not limited to convolutional neural networks, traditional transformers, Variational Autoencoders, and diffusion models.

At the model training stage, a plurality of training data 2901 may be received by the generative AI training system 2950. Data preprocessor 2902 may receive the input data (e.g., codeword vector inputs, compressed and encrypted homomorphic data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 2902 may also be configured to create training dataset, a validation dataset, and a test set from the plurality of input data 2901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 2903 to train a predictive model for object monitoring and detection.

During model training, training output 2904 is produced and used to measure the accuracy and usefulness of the predictive outputs. During this process a parametric optimizer 2905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning core training system 2900 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 2907 to measure the system's performance. The loss function 2907 compares the training outputs with an expected output and determined how the algorithm needs to be changed in order to improve the quality of the model output. During the training stage, all outputs may be passed through the loss function 2907 on a continuous loop until the algorithms 2903 are in a position where they can effectively be incorporated into a deployed model 2915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 610 in a production environment making predictions based on live input data 2911 (e.g., codeword vector inputs, compressed and encrypted homomorphic data). Further, model correlations and restorations made by deployed model can be used as feedback and applied to model training in the training stage, wherein the model is continuously learning over time using both training data and live data and predictions. A model and training database 2906 is present and configured to store training/test datasets and developed models. Database 2906 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 2903 may comprise a deep learning algorithm such as neural networks (e.g., recurrent, convolutional, long short-term memory networks, etc.).

In some implementations, the machine learning core training system 2900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 2906.

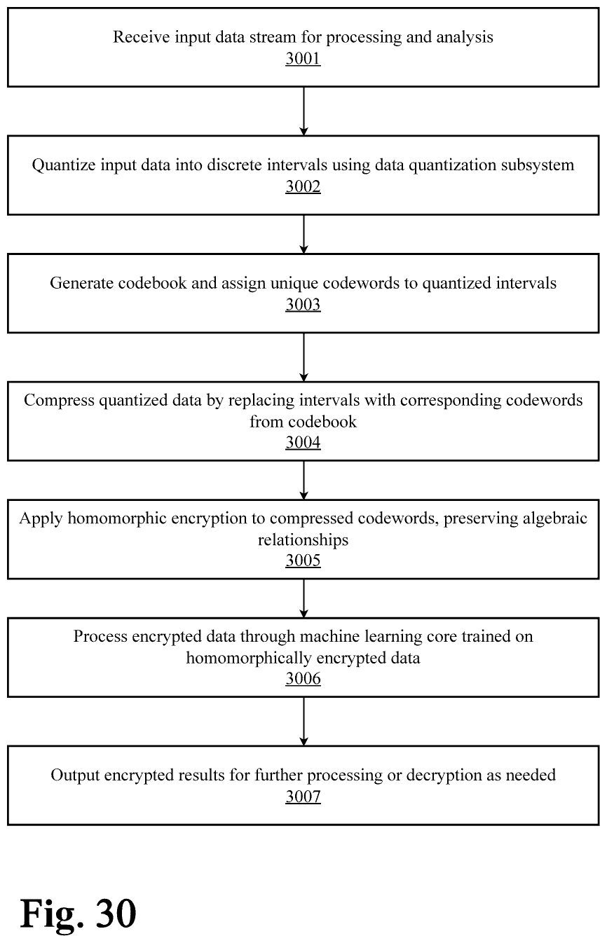

FIG. 30 is a flow diagram illustrating an exemplary method for processing homomorphic compressed and encrypted data through a deep learning platform. In a first step 3001, the system receives an input data stream for processing and analysis. Take for example, credit scores where this input would be a continuous flow of credit score data from various financial institutions. This data stream is rich with information, containing not just the raw credit scores, but also associated financial details that contribute to these scores. These could include payment history, credit utilization ratios, length of credit history, types of credit accounts, and recent credit inquiries. The system is designed to handle this constant influx of data, preparing it for the subsequent steps of compression and encryption.

In a step 3002, the system quantizes the input data into discrete intervals using the data quantization subsystem. This process is fundamental to reducing the complexity of the data while preserving its essential characteristics. For credit scores, which typically range from 300 to 850, the system might divide this range into smaller intervals. For instance, it could create 55 intervals of 10 points each. Under this scheme, a credit score of 742 would be quantized into the interval [740, 750). This quantization serves two crucial purposes: it simplifies the data representation, making it more manageable for compression and encryption, and it provides an initial layer of privacy by grouping similar scores together.

In a step 3003, the system generates a codebook and assigns unique codewords to the quantized intervals. The system analyzes the frequency distribution of the quantized intervals and assigns codewords accordingly. Using techniques like Huffman coding, it assigns shorter codewords to more frequently occurring credit score ranges and longer codewords to less common ranges. For example, if credit scores in the 700-750 range are most common in the dataset, they might be assigned shorter codewords like ‘101’ or ‘110’. Conversely, less common ranges like 300-350 might get longer codewords such as ‘1110001’. This approach optimizes the overall compression by representing the most common data points with the least amount of information.

In a step 3004, the system compresses the quantized data by replacing intervals with corresponding codewords from the codebook. Each credit score in the input data is replaced by the codeword corresponding to its quantized interval. So, continuing our example, a credit score of 742 would be replaced with the codeword ‘101’ (assuming this is the codeword assigned to the [740, 750) interval). This compression significantly reduces the amount of data that needs to be stored or transmitted, while still retaining the essential information about each credit score.

In a step 3005, the system applies homomorphic encryption to the compressed codewords, preserving algebraic relationships. This step enables secure computations on the encrypted data. Homomorphic encryption schemes allow for certain mathematical operations to be performed on encrypted data, with the results of these operations being meaningful when decrypted. For credit scores, this means that financial institutions or credit bureaus could perform calculations, updates, or analyses on the encrypted scores without ever needing to decrypt them. For instance, they could compute average credit scores for different demographics or adjust scores based on new information, all while working with encrypted data. This maintains the privacy of individual scores throughout the analysis process.

In a step 3006, the system processes the encrypted data through a machine learning core trained on homomorphically encrypted data. This step represents a significant advancement in secure data analysis. The machine learning model is specially designed to work with encrypted data, performing complex analyses and predictions without ever decrypting the underlying information. In the credit score context, this could involve predicting future credit trends, identifying potential credit risks, or segmenting customers into risk categories. The model might analyze patterns in credit score changes over time, correlations between different financial behaviors and credit scores, or the impact of economic factors on credit health. All of this is done while the data remains in its encrypted state, ensuring that even the machine learning process doesn't compromise individual privacy.

In a step 3007, the system outputs encrypted results for further processing or decryption as needed. These results could take various forms depending on the analysis performed. They might include aggregated statistics about credit score distributions, risk assessments for lending decisions, or predictions about future credit trends. Importantly, these outputs remain encrypted, allowing for secure sharing of insights derived from the credit score data without exposing individual information. Only parties with the proper decryption keys would be able to access the unencrypted results. This provides a powerful way to derive valuable insights from sensitive financial data while maintaining strict control over who can access the raw information. It allows for collaboration and analysis across different financial institutions or regulatory bodies without compromising the privacy of individual consumers.

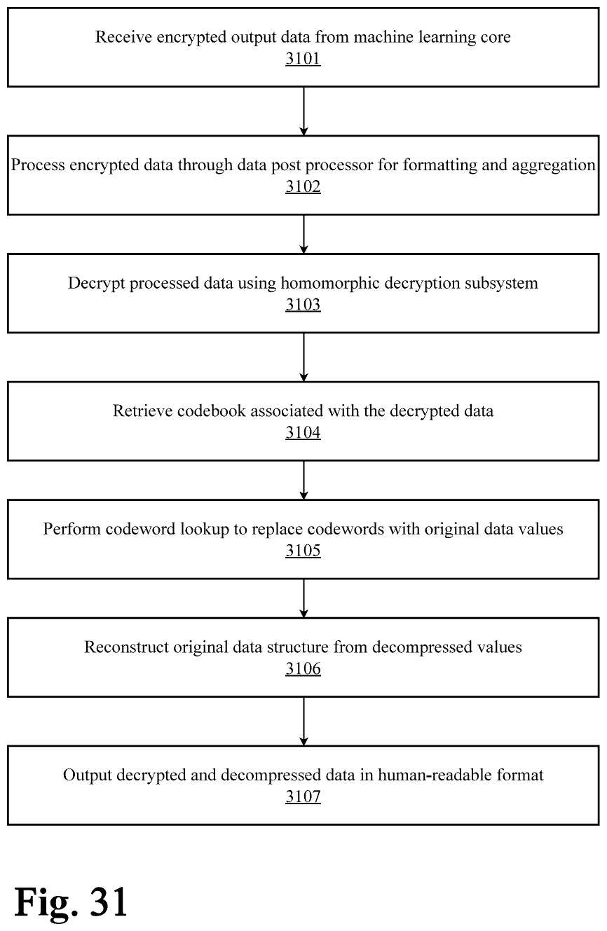

FIG. 31 is a flow diagram illustrating an exemplary method for decompressing and decrypting homomorphic compressed and encrypted data after being processed by deep learning platform. In a first step 3101, the system receives encrypted output data from the machine learning core. This data represents the results of complex analyses performed on the input to the machine learning core. Continuing the credit score example, the received encrypted data may include encrypted predictions about credit risk levels, segmented customer groups based on credit behaviors, or forecasted credit score trends. At this stage, the data is still in its fully encrypted and compressed form, ensuring that the privacy of individual credit information has been maintained throughout the analysis process.

In a step 3102, the system processes the encrypted data through a data post processor for formatting and aggregation. This step prepares the encrypted results for decryption and decompression. A post processor might perform tasks such as combining results from multiple analyses, reformatting the data to align with specific reporting requirements, or applying final transformations needed for interpretation. In our credit score example, this could involve aggregating risk assessments across different demographic groups or formatting the encrypted results to be compatible with existing financial reporting systems.

In a step 3103, the system decrypts the processed data using the homomorphic decryption subsystem. This step reverses the homomorphic encryption applied earlier, converting the secure, encrypted representations back into their compressed codeword form. The decryption process must be handled with utmost security, as it represents the point at which the protected data becomes potentially intelligible. For our credit score analysis, this might involve decrypting aggregate statistics or risk assessments, transforming them from their secure encrypted state back into meaningful, albeit still compressed, numerical representations.

In a step 3104, the system retrieves the codebook associated with the decrypted data. This codebook, which was generated during the initial compression process, contains the mapping between codewords and their corresponding data values or ranges. In the credit score scenario, this codebook would detail how each codeword relates to specific credit score intervals. For instance, it might show that the codeword ‘101’ represents the credit score range of 740-750.

In a step 3105, the system performs a codeword lookup to replace codewords with original data values. This step effectively decompresses the data, reversing the compression applied earlier in the process. Each codeword in the decrypted output is looked up in the codebook and replaced with its corresponding value or range. In the ongoing example, wherever the codeword ‘101’ appears in the decrypted output, it would be replaced with the credit score range 740-750. This process is applied to all codewords, gradually reconstructing the original data structure.

In a step 3106, the system reconstructs the original data structure from the decompressed values. This involves reassembling the full context and relationships of the data that may have been separated during the compression and encryption process. For the credit score analysis, this might mean reconnecting credit scores with their associated financial behaviors, or reconstructing the relationships between different credit factors that contribute to the overall score. The system ensures that the decompressed data accurately reflects the structure and context of the original input data.

In a step 3107, the system outputs the decrypted and decompressed data in a human-readable format. This final step transforms the data from its secure, compressed, and encrypted state back into a form that can be easily interpreted and used by authorized personnel. In the context of the credit score example, this could be a report showing clear, readable credit score predictions, risk assessments, or trend analyses. For instance, it might show that “customers in the 30-40 age group are predicted to see an average credit score increase of 15 points over the next year” or “10% of customers in the 700-750 credit score range are at risk of dropping below 700 in the next six months.” This human-readable output allows financial institutions, credit bureaus, or other authorized parties to make informed decisions based on the secure analysis of sensitive credit data, all while having maintained the privacy and security of individual credit information throughout the entire process.

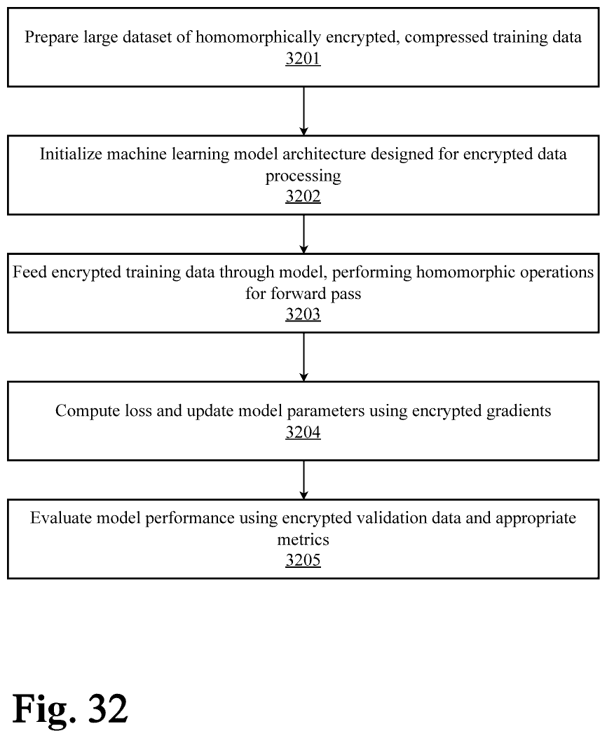

FIG. 32 is a flow diagram illustrating an exemplary method for training a machine learning core on processing homomorphic compressed and encrypted data. In a first step 3201, the system prepares a large dataset of homomorphically encrypted, compressed training data. This is a crucial first step in the process of training a machine learning model that can operate on encrypted data. Using credit score as an example, this dataset may consist of a vast number of encrypted, compressed credit records. Each record might include the encrypted, compressed representations of credit scores, payment histories, credit utilization ratios, and other relevant financial data. The data is first compressed using the codebook-based method described earlier, then encrypted using a homomorphic encryption scheme. This allows the data to retain its mathematical properties even in its encrypted state, which is essential for the subsequent machine learning process. The preparation of this dataset is a significant undertaking, requiring careful consideration of data diversity to ensure the model can learn to make accurate predictions across a wide range of credit scenarios.

In a step 3202, the system initializes a machine learning model architecture designed for encrypted data processing. This is not a standard machine learning model, but a specialized architecture capable of performing computations on encrypted data. The model might be a neural network with layers specifically designed to handle homomorphically encrypted inputs and perform encrypted operations. In other embodiments, the machine learning model may be a latent transformer where the positional and embedding layers have been removed. For credit score analysis, this model could be structured to identify patterns in encrypted credit behavior that correlate with future credit score changes or credit risks. The initialization process involves setting up the model's structure, defining its layers, and preparing it to process the encrypted, compressed credit data. This specialized architecture ensures that the model can learn and make predictions without ever decrypting the sensitive financial information.

In a step 3203, the system feeds the encrypted training data through the model, performing homomorphic operations for the forward pass. During this step, the encrypted, compressed credit data is processed through the layers of the neural network. The model performs computations on the encrypted data, such as matrix multiplications and activation functions, all while the data remains in its encrypted state. For the credit score example, this might involve the model analyzing encrypted patterns in payment history, credit utilization, and other factors to learn their relationships with credit score outcomes. The homomorphic properties of the encryption allow these computations to be meaningful, even though the model never sees the actual, unencrypted credit scores or financial data.

In a step 3204, the system computes the loss and updates the model parameters using encrypted gradients. This is a critical step in the training process, where the model's predictions are compared to the actual outcomes (all in encrypted form) to compute a loss value. This loss is then used to calculate gradients, which indicate how the model's parameters should be adjusted to improve its performance. In the context of credit score prediction, the model might be adjusting its understanding of how different encrypted financial behaviors impact future credit scores. All of these computations, the loss calculation, gradient computation, and parameter updates, must be performed on encrypted data. This ensures that at no point during the training process is the sensitive financial information exposed.

In a step 3205, the system evaluates the model's performance using encrypted validation data and appropriate metrics. This step is helps understand how well the model is learning and generalizing from the training data. A separate set of encrypted, compressed credit records is used for this validation. The model makes predictions on this validation set, and its performance is evaluated using metrics that can be computed on encrypted data. For credit score prediction, this might involve calculating encrypted versions of metrics like mean absolute error or root mean squared error to assess the accuracy of the model's credit score predictions. The system might also evaluate the model's performance in identifying high-risk credit behaviors, all while working with encrypted data. This evaluation process helps in fine-tuning the model and ensuring that it can make accurate predictions on new, unseen credit data while maintaining the privacy and security of the underlying financial information.

This method of training a machine learning model on homomorphically encrypted and compressed data represents a significant advancement in privacy-preserving machine learning. It allows for the development of powerful predictive models in sensitive domains like credit scoring, without ever exposing the underlying individual data. This approach could revolutionize how financial institutions and credit bureaus develop and use predictive models, enabling more sophisticated risk assessments and credit analyses while strongly protecting consumer privacy.

### Exemplary Computing Environment

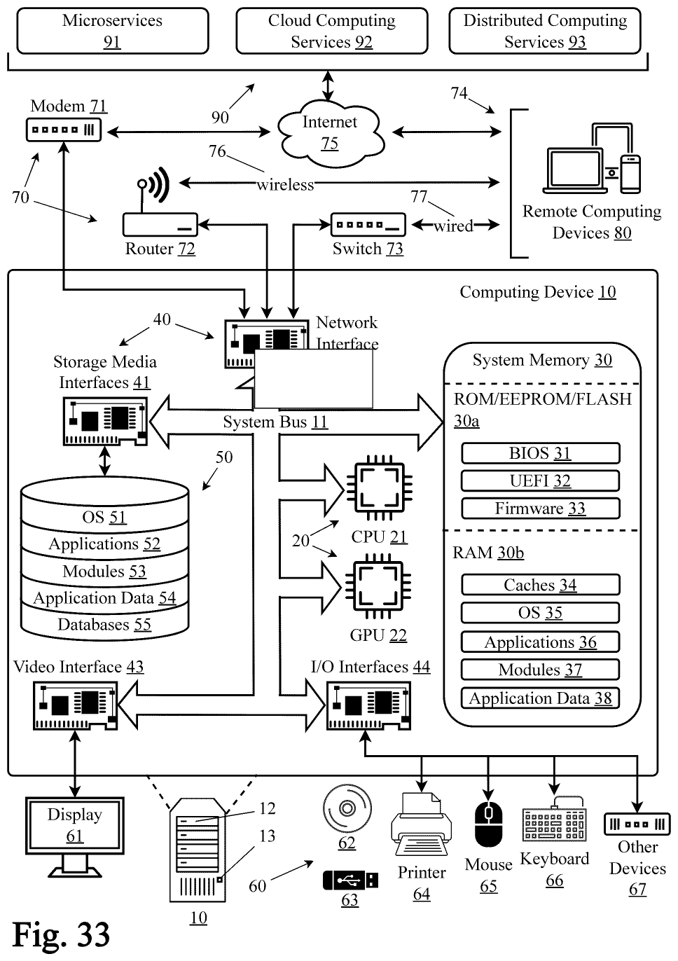

FIG. 33 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for operating a deep learning architecture on homomorphically compressed and encrypted data, comprising one or more computers with executable instructions that, when executed, cause the deep learning system to:
sense input data from a data source;
compress the input data into a plurality of compressed codewords by allocating codewords to sections of the input data;
encrypt the plurality of compressed codewords into a plurality of encrypted and compressed codewords using a homomorphic encryption algorithm;
process the plurality encrypted and compressed codewords through a machine learning core, wherein the machine learning core produces a plurality of inferences based on the encrypted and compressed codewords; and
modify the data source or the input data based on the plurality of inferences.

2. The system of claim 1, wherein the machine learning core uses a latent transformer architecture.

3. The system of claim 1, wherein the machine learning core produces a plurality of predictions based on the plurality of encrypted and compressed codewords.

4. The system of claim 1, wherein the input data is quantized before allocating codewords to sections of the input data.

5. A method for operating a deep learning architecture on homomorphically compressed and encrypted data, comprising the steps of:
sensing input data from a data source;
compressing the input data into a plurality of compressed codewords by allocating codewords to sections of the input data;
encrypting the plurality of compressed codewords into a plurality of encrypted and compressed codewords using a homomorphic encryption algorithm;
processing the plurality encrypted and compressed codewords through a machine learning core, wherein the machine learning core produces a plurality of inferences based on the encrypted and compressed codewords; and
modifying the data source or the input data based on the plurality of inferences.

6. The method of claim 5, wherein the machine learning core uses a latent transformer architecture.

7. The method of claim 5, wherein the machine learning core produces a plurality of predictions based on the plurality of encrypted and compressed codewords.

8. The method of claim 5, wherein the input data is quantized before allocating codewords to sections of the input data.
